SEQUENCE LISTING (53 sequences)

SEQ ID NO: 1 - protein, 25 aa, Artificial Sequence
  Description of Artificial Sequence Synthetic peptide
  MOD_RES (2)..(5): Variable amino acid and this region may encompass2 to 4 residues
  MOD_RES (7)..(18): Variable amino acid
  MOD_RES (20)..(24): Variable amino acid and this region may encompass3 to 5 residues
CXXXXCXXXXXXXXXXXXHXXXXXH

SEQ ID NO: 2 - protein, 7 aa, Artificial Sequence
  Description of Artificial Sequence Synthetic peptide
DRSSLTR

SEQ ID NO: 3 - protein, 7 aa, Artificial Sequence
  Description of Artificial Sequence Synthetic peptide
QGGNLVR

SEQ ID NO: 4 - protein, 7 aa, Artificial Sequence
  Description of Artificial Sequence Synthetic peptide
QAATLQR

SEQ ID NO: 5 - DNA, 3 bp, Artificial Sequence
  Description of Artificial Sequence Synthetic oligonucleotide
gcc

SEQ ID NO: 6 - DNA, 3 bp, Artificial Sequence
  Description of Artificial Sequence Synthetic oligonucleotide
gaa

SEQ ID NO: 7 - DNA, 3 bp, Artificial Sequence
  Description of Artificial Sequence Synthetic oligonucleotide
gca

SEQ ID NO: 8 - protein, 18 aa, Artificial Sequence
  Description of Artificial Sequence Synthetic peptide
DRSSTRQGGNVRQAATQR

SEQ ID NO: 9 - DNA, 9 bp, Artificial Sequence
  Description of Artificial Sequence Synthetic oligonucleotide
gcagaagcc

SEQ ID NO: 10 - protein, 18 aa, Artificial Sequence
  Description of Artificial Sequence Synthetic peptide
RKDSVRQSGDRRDCRDAR

SEQ ID NO: 11 - DNA, 9 bp, Artificial Sequence
  Description of Artificial Sequence Synthetic oligonucleotide
gccgcagtg

SEQ ID NO: 12 - protein, 18 aa, Artificial Sequence
  Description of Artificial Sequence Synthetic peptide
ASADTRNRSDSRTSSNKK

SEQ ID NO: 13 - DNA, 9 bp, Artificial Sequence
  Description of Artificial Sequence Synthetic oligonucleotide
gatgctgca

SEQ ID NO: 14 - DNA, 25 bp, Artificial Sequence
  Description of Artificial Sequence Synthetic oligonucleotide
ttttcgacacgcagaagcccattac

SEQ ID NO: 15 - DNA, 25 bp, Artificial Sequence
  Description of Artificial Sequence Synthetic oligonucleotide
ttttcgacaagccgcagtggattac

SEQ ID NO: 16 - DNA, 25 bp, Artificial Sequence
  Description of Artificial Sequence Synthetic oligonucleotide
ttttcgacacgatgctgcatattac

SEQ ID NO: 17 - DNA, 25 bp, Artificial Sequence
  Description of Artificial Sequence Synthetic oligonucleotide
ttttgacggtgcgtgggcggttcac

SEQ ID NO: 18 - protein, 18 aa, Artificial Sequence
  Description of Artificial Sequence Synthetic peptide
DSPTRRQGANRRQANTQR

SEQ ID NO: 19 - protein, 18 aa, Artificial Sequence
  Description of Artificial Sequence Synthetic peptide
DSPTRRQNTNTRQANTQR

SEQ ID NO: 20 - protein, 18 aa, Artificial Sequence
  Description of Artificial Sequence Synthetic peptide
DSPTRRQNTNTRQANTQR

SEQ ID NO: 21 - protein, 18 aa, Artificial Sequence
  Description of Artificial Sequence Synthetic peptide
DESTRRQGPNRRQRNTQR

SEQ ID NO: 22 - protein, 18 aa, Artificial Sequence
  Description of Artificial Sequence Synthetic peptide
DSPTRRQGPNRRQGNTTR

SEQ ID NO: 23 - protein, 18 aa, Artificial Sequence
  Description of Artificial Sequence Synthetic peptide
DSPTRRQNPNVRQRNTQR

SEQ ID NO: 24 - protein, 18 aa, Artificial Sequence
  Description of Artificial Sequence Synthetic peptide
DSPTRRQRTNIRQRNTQR

SEQ ID NO: 25 - protein, 18 aa, Artificial Sequence
  Description of Artificial Sequence Synthetic peptide
DRPTRRQGANRRQANTQR

SEQ ID NO: 26 - protein, 18 aa, Artificial Sequence
  Description of Artificial Sequence Synthetic peptide
DSPTRRQNTNNRQANTQR

SEQ ID NO: 27 - protein, 18 aa, Artificial Sequence
  Description of Artificial Sequence Synthetic peptide
DSPTRRQKPNDRQGNSIR

SEQ ID NO: 28 - protein, 18 aa, Artificial Sequence
  Description of Artificial Sequence Synthetic peptide
DSPTRRQSTNNRQGNSNR

SEQ ID NO: 29 - protein, 18 aa, Artificial Sequence
  Description of Artificial Sequence Synthetic peptide
DSPTRRQNVNTRQRNTQR

SEQ ID NO: 30 - protein, 18 aa, Artificial Sequence
  Description of Artificial Sequence Synthetic peptide
RQDIVKQSSTTREKQGHR

SEQ ID NO: 31 - protein, 18 aa, Artificial Sequence
  Description of Artificial Sequence Synthetic peptide
RSDVANQSSTTRERQGKR

SEQ ID NO: 32 - protein, 18 aa, Artificial Sequence
  Description of Artificial Sequence Synthetic peptide
RSDVANQSSTTRERQGKR

SEQ ID NO: 33 - protein, 18 aa, Artificial Sequence
  Description of Artificial Sequence Synthetic peptide
RSDLRKQSSTTRERQGKR

SEQ ID NO: 34 - protein, 18 aa, Artificial Sequence
  Description of Artificial Sequence Synthetic peptide
RPDVDKQSSTTRDSTTRR

SEQ ID NO: 35 - protein, 18 aa, Artificial Sequence
  Description of Artificial Sequence Synthetic peptide
RSDVANQSSTTREKQGGR

SEQ ID NO: 36 - protein, 18 aa, Artificial Sequence
  Description of Artificial Sequence Synthetic peptide
RSDLTKQSGTKRERQGKR

SEQ ID NO: 37 - protein, 18 aa, Artificial Sequence
  Description of Artificial Sequence Synthetic peptide
RSDLTKQSSTTREKQGRR

SEQ ID NO: 38 - protein, 18 aa, Artificial Sequence
  Description of Artificial Sequence Synthetic peptide
RSDVSKQSTTKRERQGKR

SEQ ID NO: 39 - protein, 18 aa, Artificial Sequence
  Description of Artificial Sequence Synthetic peptide
RQDIVKQSSTTREKQGHR

SEQ ID NO: 40 - protein, 18 aa, Artificial Sequence
  Description of Artificial Sequence Synthetic peptide
RSDLTKQSSTTRERQGKR

SEQ ID NO: 41 - protein, 18 aa, Artificial Sequence
  Description of Artificial Sequence Synthetic peptide
RPDVQKQSGTVRDQSNRR

SEQ ID NO: 42 - protein, 18 aa, Artificial Sequence
  Description of Artificial Sequence Synthetic peptide
LRADDNLSQTKRIRGNVR

SEQ ID NO: 43 - protein, 18 aa, Artificial Sequence
  Description of Artificial Sequence Synthetic peptide
AKADDRLSQTKRVKSNRR

SEQ ID NO: 44 - protein, 18 aa, Artificial Sequence
  Description of Artificial Sequence Synthetic peptide
LRADDRLSQTKRIGSNRR

SEQ ID NO: 45 - protein, 18 aa, Artificial Sequence
  Description of Artificial Sequence Synthetic peptide
LRADDRLSQTKRVKSNRR

SEQ ID NO: 46 - protein, 18 aa, Artificial Sequence
  Description of Artificial Sequence Synthetic peptide
LRTDDRLSQTQRLNSNAR

SEQ ID NO: 47 - protein, 18 aa, Artificial Sequence
  Description of Artificial Sequence Synthetic peptide
LRTDDRLSQTRRLRSNGR

SEQ ID NO: 48 - protein, 18 aa, Artificial Sequence
  Description of Artificial Sequence Synthetic peptide
LRADDRLSQTKRMRSNMR

SEQ ID NO: 49 - protein, 18 aa, Artificial Sequence
  Description of Artificial Sequence Synthetic peptide
LRADDRLRQTKRLRANLR

SEQ ID NO: 50 - protein, 18 aa, Artificial Sequence
  Description of Artificial Sequence Synthetic peptide
LRADDRLAQTKRIGSNTR

SEQ ID NO: 51 - protein, 18 aa, Artificial Sequence
  Description of Artificial Sequence Synthetic peptide
LRTDDRLSQTNRLQGNKR

SEQ ID NO: 52 - protein, 18 aa, Artificial Sequence
  Description of Artificial Sequence Synthetic peptide
LRADDRLRQTKRLRANLR

SEQ ID NO: 53 - protein, 18 aa, Artificial Sequence
  Description of Artificial Sequence Synthetic peptide
NNAMVRLSQTQRMQGNSR

(19) United States
(12) Patent Application Publication
(10) Pub. No.: US 2007/0178454 A1
(43) Pub. Date: Aug. 2, 2007

(54) Context sensitive paralell optimization of zinc finger dna binding domains

(76) Inventors: J. Keith Joung, Winchester, MA (US); Carl Pabo, Mill Valley, CA (US)

Correspondence Address: EDWARDS ANGELL PALMER & DODGE LLP, P.O. BOX 55874, BOSTON, MA, 02205, US

(21) Appl. No.: 10/532,258

(22) PCT Filed: Oct. 23, 2003
(86) PCT No.: PCT/US03/34010

§ 371 Date: Oct. 2, 2006

Related U.S. Application Data
(60) Provisional application No. 60/420,485, filed on Oct. 21, 2002.
(60) Provisional application No. 60/466,889, filed on Apr. 30, 2003.

(51) Int. Cl. C40B 30/06; C40B 40/08; C40B 40/10

(52) U.S. Cl. 435/6; 435/7.1

(57) ABSTRACT

The present invention relates to methods of identifying multi-finger Zf polypeptides that bind to a sequence of interest. Zf polypeptides identified using the methods described herein can have affinity and specificity for their target sites that is superior to those produced by alternative methods.

### RELATED APPLICATIONS/PATENTS & INCORPORATION BY REFERENCE

This application claims priority to U.S. application Ser. No. 60/420,458 filed Oct. 23, 2002, and U.S. application Ser. No. 60/466,889 filed Apr. 30, 2003, the contents of which are hereby expressly incorporated herein by reference.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. More generally, documents or references are cited in this text, either in a Reference List before the claims, or in the text itself; and, each of these documents or references (“herein cited references”), as well as each document or reference cited in each of the herein-cited references (including any manufacturer's specifications, instructions, etc.), is hereby expressly incorporated herein by reference.

### STATEMENT OF RIGHTS TO INVENTION MADE UNDER FEDERALLY SPONSORED RESEARCH

This work was supported by the government, in part, by a grant from the National Institute of Health and the National Institute of Diabetes and Digestive and Kidney Diseases (K08 DK02883). The government may have certain rights to this invention.

### FIELD OF THE INVENTION

The present invention relates to Zinc finger polypeptides having DNA binding domains, and to methods of selecting Zinc finger polypeptides that bind to sequences of interest.

### BACKGROUND OF THE INVENTION

At any given time, only a fraction of the genes in the genome of an organism are expressed and/or producing functional protein products. The profile of proteins expressed in an organism varies greatly between cell types and changes over time, depending on factors such as stage of development, stage of the cell cycle and response to environmental factors. Furthermore, gene expression is often mis-regulated in disease.

Gene expression is controlled, in part, by proteins known as transcription factors. The presence of a particular combination of such transcription factors determines whether a gene is switched on or off at any given time and place. Transcription factors are modular proteins. They contain at least one DNA-binding domain (DBD) and one or more functional domains. DBDs act as targeting devices to localize transcription factors to specific sequences or “target sites” on the chromosomal DNA. Functional domains function to direct the localization of specific activities to a gene or locus of interest, ultimately enabling transcription of that gene to be up- or down regulated.

The ability to artificially manipulate gene expression has enormous potential for biological research and for the development of new agents for gene therapy. Realizing this potential requires the ability to engineer DNA binding domains that recognize “target site” sequences with high affinity and specificity. Many DNA-binding proteins contain independently folded domains for the recognition of DNA, and these domains in turn belong to a large number of structural families, such as the leucine zipper, the “helix-turn-helix” and zinc finger (Zf) families. Most sequence-specific DNA-binding proteins bind to the DNA double helix by inserting an α-helix into the major groove (Pabo and Sauer 1992 Annu. Rev. Biochem. 61:1053-1095; Harrison 1991 Nature (London) 353: 715-719; and Klug 1993 Gene 135:83-92). Sequence specificity results from the geometrical and chemical complementarity between the amino acid side chains of the α-helix and the accessible groups exposed on the edges of base-pairs. In addition to this direct reading of the DNA sequence interactions with the DNA backbone stabilize the complex and are sensitive to the conformation of the nucleic acid, which in turn depends on the base sequence (Dickerson and Drew 1981 J. Mol. Biol. 149:761-786).

Zfs have become the DBD of choice in efforts to engineer custom-made transcription factors. A Zf is an independently folded zinc-containing mini-domain, the structure of which is well known in the art and defined in, for example, Miller et al., (1985) EMBO J. 4:1609; Berg (1988) Proceedings of the National Academy of Sciences (USA) 85:99; Lee et al., (1989) Science 245:635 and Klug, (1993) Gene 135:83. Crystal structures of zif268 and its variants bound to DNA show a semi-conserved pattern of interactions, in which typically 3 amino acids from the a-helix of the Zf contact 3 adjacent base pairs (bp) or a “subsite” in the DNA (Pavletich et al., (1991) Science 252:809; Elrod-Erickson et al. (1998) Structure 6:451). Thus, the crystal structure of Zif268 suggested that Zf DBDs might function in a modular manner with a one-to-one interaction between a Zf and a 3 bp “subsite” in the DNA sequence. In naturally occurring transcription factors, multiple Zfs are typically linked together in a tandem array to achieve sequence-specific recognition of a contiguous DNA sequence (Klug, (1993) Gene 135:83).

Multiple studies have shown that it is possible to artificially engineer the DNA binding characteristics of individual Zfs by randomizing the amino acids at the α-helical positions involved in DNA binding and using selection methodologies such as phage display to identify desired variants capable of binding to DNA target sites of interest (Rebar et al., (1994) Science 263:671; Choo et al., (1994) Proceedings of the National Academy of Sciences (USA) 91:11163; Jamieson et al., (1994) Biochemistry 33:5689; Wu et al., (1995) Proceedings of the National Academy of Sciences (USA) 92: 344). Furthermore, by fusing such recombinant Zf DBDs to functional domains, it has been possible to artificially regulate expression of transfected reporter genes in cultured cells. For example, Beerli et al., (Beerli et al., (1998) Proceedings of the National Academy of Sciences (USA) 95:14628) reported construction of a chimeric six finger Zf protein fused to either a KRAB, ERD, or SID transcriptional repressor domain, or the VP16 or VP64 transcriptional activation domain. This chimeric Zf protein was designed to recognize an 18 bp target site in the 5′ untranslated region of the human erbB-2 gene. Using this construct, the authors were able to either activate or repress a transiently expressed reporter luciferase construct linked to the erbB-2 promoter.

Further studies have demonstrated that such recombinant Zf transcription factors can also be used to regulate expression of endogenous genes in their native chromosomal context (Reik et al., (2002) Current Opinions in Genetics & Development 12:233). Clinically relevant human genes that have been successfully regulated in this way include MDR1, erythropoietin, erbB-2 and erbB-3, VEGF, PPARgamma, and CHK2. In the case of VEGF (Liu et al., (2001) Journal of Biological Chemistry 276:11323), proportional up-regulation by the designed transcription factor of all three distinct splice isoforms generated by this locus was observed, illuminating the utility of endogenous gene control in therapeutic settings (proper isoform ratio is essential for the proangiogenic function of VEGF). In the case of PPARgamma, use of a transcriptional repressor designed to downregulate the expression of two PPARgamma isoforms allowed “mutation-free reverse genetics” analysis that illuminated a unique role for the PPARgamma2 isoform in adipogenesis (Ren et al., (2002) Genes &Development 16:27). In the case of CHK2, a six finger protein derived from zif268 fused to a KRAB2 repressor domain produced highly s specific repression of the CHK2 gene (Tan et al. (2003) PNAS 1000:11997).

The vast majority of methods used to produce custom-designed Zf DBDs utilize large Zf libraries in which the key amino acids required for DNA binding have been randomized. To select Zfs with the desired DNA binding characteristics from such libraries most researchers use phage display technology, in which the proteins encoded by the Zf library are expressed on the surface of the bacteriophage. Phage particles displaying Zf motifs with the desired sequence specificity are identified using standard techniques that select on the basis of DNA binding affinity and specificity and are then subjected to multiple rounds of selection and amplification. Rebar and Pabo (Rebar et al., (1994) Science 263:671) first used this method to produce a recombinant version of Zif268 with altered DNA-binding specificity.

More recently a bacterial “two-hybrid” method has been developed. In this system Zf-DNA interactions are required for cell growth and survival (Joung et al., (2000) Proceedings of the National Academy of Sciences (USA) 97:7382 and US Patent Application No. 20020119498). The bacterial two-hybrid system has an extremely low background rate and, because it does not require multiple rounds of selection and amplification, it is significantly faster to perform than phage display methods. Furthermore, the bacterial two-hybrid system has an added advantage in that, unlike phage display, the Zf-DNA binding interaction occurs within living cells. Thus, Zfs identified using this method are more likely to function reliably in a cellular context. Joung et al. (Joung et al., (2000) Proceedings of the National Academy of Sciences (USA) 97:7382) demonstrated that the bacterial tww-hybrid system was at least as effective as phage display at identifying Zfs with desired binding affinities from randomized libraries.

In order to use recombinant Zfs to target a gene of interest within the genome, the target site sequence recognized should be sufficiently long that statistically it occurs only once in the genome. In the case of the human genome, a multi-finger Zf protein recognizing a stretch of about 16 bp or more should be generated for this to be achieved (Liu et al., (1997) Proceedings of the National Academy of Sciences (USA) 94:5525). Statistically, assuming random base distribution, a unique 16 bp sequence will occur only once in 4.3×10⁹ bp, thus a 16 bp sequence should be sufficient to specify a unique address within the approximately 3.5×10⁹ bp that make up the human genome (Liu et al., (1997) Proceedings of the National Academy of Sciences (USA) 94:5525). Similarly, an 18 bp address specified by a six finger protein, would enable sequence specific targeting within 6.8×10¹⁰ bp of DNA. Such a six-finger protein would thus be able to uniquely specify any locus within all currently known genomes. However, it should be noted that the “effective” frequency of such unique addresses in the human genome is likely to be significantly lower than the frequencies predicted by these purely statistical calculations, because a certain portion of the DNA in the genome is packaged into regions of densely packed chromatin that is not accessible by transcription factors.

At present there are three main methods by which such multi-finger Zf proteins can be selected from a library and produced. These are referred to herein as the parallel selection, sequential selection and bipartite selection methods (for review, see Beerli and Barbas, (2002) Nature Biotechnology 20:135).

The basic assumption of parallel selection is that individual Zf domains are functionally independent and can therefore be recombined with one another to recognize any desired DNA sequence. Thus, individual fingers selected to bind to any given 3 bp subsite can be “stitched” together to produce a multi-finger DBD. Although several multi-finger proteins have been produced using this method (including Desjarlais et al., (1993) Proceedings of the National Academy of Sciences (USA) 90:2256; Choo et al., (1994) Nature 372:642), a major limitation arises from the oversimplified model on which it is based, i.e., that Zfs bind DNA as independent modular units. In reality, differences in the amino acid sequence of one Zf, can affect the function of neighboring fingers. In other words, there exists in some natural Zf proteins the propensity for necessary interaction between individual Zf domains, or “positions,” termed finger “context dependence” or “position sensitivity.” For example, inter-finger contacts have been reported in the crystal structures of synthetic-zinc finger proteins selected to bind to a TATA box sequence (Wolfe et al., (2001) Structure 9:717).

In addition, it has been noted that some Zfs display “target-site overlap,” in which zinc finger domains work cooperatively to recognize DNA sequence at their subsite junctions (Pavletich et al., (1991) Science 252:809; Elrod-Erickson et al., (1996) Structure 4:1171; Kim et al., (1996) Nature Structural Biology 3:940; Isalan et al., (1997) Proceedings of the National Academy of Sciences (USA) 94:5617). Thus, although the parallel selection method can identify functional multi-finger DBDs, ignoring the importance of finger context may produce sub-optimal multi-finger proteins.

The sequential selection method was developed by Greisman and Pabo (Greisman et al., (1997) Science 275:657 and U.S. Pat. No. 6,410,248) in an attempt to address the lack of context dependence that plagues the parallel selection method. In this method, DNA-binding specificities of individual Zf domains are altered sequentially in the context of the other Zfs. Thus, finger three of a three-finger protein is replaced by a finger one in which the critical amino acid residues have been randomized. This library is then selected in the context of the two original fingers, which serve as anchors. After selection, the N-terminal anchor finger is removed and a finger two library is attached to the C-terminus. Selection of this library ensures that the new finger two works well in the context of the finger one selected in the previous round. In the final step, the last remaining anchor finger is discarded and a randomized finger three is attached to the C-terminus, again followed by selection. In this manner, each finger of the new three-finger protein is selected in the context of its neighboring finger, preventing problems associated with target site overlap. Recently the crystal structure of a sequentially selected protein in complex with its TATA box target sequence has been reported (Wolfe et al., (2001) Structure 9:717). Although sequential selection undoubtedly overcomes the problems associated with the parallel selection method, the need to sequentially generate multiple Zf libraries for each protein produced makes this a very labor- and time-intensive procedure and therefore, not suitable for repeated or high-throughput use.

The most recently developed Zf selection protocol is the bipartite method. This technique was developed by Isalan et al. (Isalan et al., (2001) Nature Biotechnology 19: 656) with the aim of combining the advantages of the parallel and sequential methods but avoiding the context sensitivity problems of the parallel selection method. Bipartite selection makes use of a pair of prefabricated libraries. In each library the residues in the recognition helices of one-and-a-half fingers of the three Zf protein Zif268 are randomized. Selection of these two libraries is carried out in parallel against DNA sequences in which either the first or the last 5 bp of the 9 bp Zif268 target site are replaced with the corresponding bases from a target site of interest. After phage display selection, pools of binding fingers from the two prefabricated libraries are recombined to produce a partially selected library of three finger proteins. Further rounds of selection are then performed against the full 9 bp sequence of interest. Isalan et al. (Isalan et al., (2001) Nature Biotechnology19:656) used this method to select three finger proteins that bind to sequences within the HIV-1 promoter and found that the proteins produced had affinities comparable to those of Zfs produced using the parallel and sequential strategies.

Thus, the bipartite method avoids target site overlap and position sensitivity problems associated with parallel selection, and also avoids the multiple library production problem associated with sequential selection. However, these benefits have been achieved at the expense of combinatorial diversity. The need to randomize 8 to 10 amino acids within each one-and-a-half finger library presents a combinatorial problem beyond the capability of existing library construction and selection methods, if significant randomization of the residues is permitted. In an attempt to overcome this defect, Isalan et al. designed the two libraries used in the initial selection to limit the number of amino acid variations. However, this “pre-selection” at the level of the starting libraries means that the full range of all possible Zfs are not produced and thus optimal fingers may not even be present in the original libraries.

Although several techniques exist for selecting multi-finger proteins, each of these methods has limitations. An ideal multi-Zf selection strategy would involve one or more, or preferably all of the following elements:
a) retaining maximal combinatorial diversity in the Zf libraries used,
b) avoiding prior assumptions about the role of particular amino acids in binding,
c) overcoming the problems of target-site overlap and position sensitivity,
d) screening or selection of full length assembled multi-finger Zf proteins directly against the sequence of interest,
e) avoiding post-selection assembly of individual Zfs or groups of Zfs,
f) allowing selection of Zfs which bind to their target sites in a cellular context, and
g) simplifying and expediting procedures for use in high-throughput applications.

Prior to the development of the methods described herein, no strategy was known to combine all of these features.

### OBJECT AND SUMMARY OF THE INVENTION

The present invention provides methods for rapidly selecting multi-finger Zf polypeptides that bind to any desired sequence of interest comprising a target site, termed “context sensitive parallel optimization” (CSPO). CSPO overcomes the problems of target site overlap and context sensitivity associated with other methods, without sacrificing combinatorial diversity. A schematic illustration of a CSPO strategy is provided in FIG. 1. CSPO uses master libraries in which up to 20 amino acids can be represented at each of the sites randomized within a single Zf, and requires the construction of only one new “secondary” library for each multi-finger polypeptide constructed. In addition, CSPO allows for efficient selection of pre-assembled multi-finger Zf polypeptides having the desired DNA sequence specificity. Methods of the present invention can be used in conjunction with the classical systems known in the art for Zf selection, such as phage-display or polysome systems. Preferably, methods of the present invention can be used in conjunction with prokaryotic or eukaryotic cell-based selection methods (e.g. a bacterial, yeast or mammalian two-hybrid systems), thus ensuring that a multi-finger polypeptide selected functions well in a cellular context. In summary, the methods of the present invention provide a rapid and feasible means to select optimized multi-finger proteins with high affinity and specificity.

Accordingly, in one aspect, the present invention provides A method of selecting a zinc finger polypeptide that binds to a sequence interest comprising at least two subsites, said method comprising the steps of:
a) incubating position-sensitive primary libraries with target site constructs under conditions sufficient to form first binding complexes, wherein said primary libraries comprise zinc finger polypeptides having one variable finger and at least one anchor finger, and wherein the target site construct has one subsite with a sequence identical to a subsite of the sequence of interest, and one or more subsites with sequences to which the anchor finger(s) bind,
b) isolating pools comprising nucleic acid sequences encoding polypeptides, wherein said polypeptides comprise the first binding complexes;
c) recombining the pools to produce a secondary library;
d) incubating the secondary library with the sequence of interest under conditions sufficient to form second binding complexes; and
e) isolating nucleic acid sequences encoding zinc finger polypeptides, wherein said polypeptides comprise the second binding complexes.

The composition of the primary libraries, which are carefully controlled to maintain combinatorial diversity, coupled with the composition of the secondary libraries, which are carefully controlled to account for finger position sensitivity, results in the improved selection of Zf proteins.

These and other objects and embodiments within the scope of the invention, are described in or are obvious from the following Detailed Description.

### BRIEF DESCRIPTION OF THE DRAWINGS

In the following Detailed Description and Examples reference will be made to the accompanying drawings, incorporated herein by reference.

FIG. 1 provides a schematic representation of the required components and steps of the context-sensitive parallel optimization (CSPO) Zf selection strategy that is the object of the present invention.

FIG. 2 provides a schematic representation of the PCR-mediated recombination protocol for generation of the secondary libraries used in CSPO.

FIG. 3 shows the characterization of a CSPO-selected finger by EMSA (A) and the measurement of the KD for binding to its specific target (B), as described in Example 4.

FIG. 4 shows the characterization of a CSPO-selected finger by EMSA (A) and the measurement of the K_{D} for binding to non-specific DNA (B), as described in Example 4.

FIG. 5 shows the DNA binding sites (A) and amino acid sequences (B) of multi-finger proteins previously selected by others, using methods other than the CSPO method of the present invention. These previously selected zinc finger proteins (B) were compared to CSPO-selected proteins designed-to bind to the same DNA binding sites (A), as described in Examples 5, 6, and 7. FIG. 5Ai) shows a binding site for BCR-ABL (SEQ ID NO. 9). Aii) shows a binding site for erb-B2 (SEQ ID NO. 11). Aiii) shows a binding site in the HIV promoter (SEQ ID NO. 13). FIG. 5Bi) shows the recognition helix sequences of the Zf protein previously selected (by parallel selection) to bind to the BCR-ABL sequence shown in Ai), as described in Example 5. Bii) shows the recognition helix sequences of the Zf protein previously selected (by parallel selelction) to bind to the erb-B2 sequence shown in Aii), as described in Example 6. Biii) shows the recognition helix sequences of the Zf protein previously selected (by bipartite selection) to bind to the HIV promoter sequence shown in Aiii), as described in Example 7.

FIG. 6 depicts recognition helix sequences of BCR-ABL target-binding Zfs selected using the CSPO methods of the present invention, and their activity in bacterial reporter gene expression assays, as described in Example 5.

FIG. 7 depicts binding affinities and specificities (determined using EMSAs) for CSPO-selected BCR-ABL target-binding Zfs, as described in Example 5.

FIG. 8 depicts recognition helix sequences of erb-B2 target-binding Zfs selected using the CSPO methods of the present invention, and their activity in bacterial reporter gene expression assays, as described in Example 6.

FIG. 9 depicts binding affinities and specificities (determined using EMSAs) for the CSPO-selected erb-B2 target-binding Zfs described in Example 6.

FIG. 10 depicts recognition helix sequences of HIV-1 promoter-binding Zfs selected using the CSPO methods of the present invention, and their activity in bacterial reporter gene expression assays, as described in Example 7.

FIG. 11 depicts binding affinities and specificities (determined using EMSAs) for the CSPO-selected HIV-1 promoter-binding Zfs described in Example 7.

### DETAILED DESCRIPTION OF THE INVENTION

I. Introduction

The present invention provides methods for the selection of multi-finger Zf polypeptides that bind to a sequence of interest. Typically the sequence of interest will be located within a gene of interest. Preferably, all of the constituent fingers of the Zf polypeptide are maximally randomized and selected simultaneously for binding to a given sequence of interest. Such a Zf selection strategy advantageously avoids position sensitivity problems while retaining the greatest possible diversity of fingers from which to perform efficient selection.

Other methods known in the art either reduce library variability to within manageable limits, thereby sacrificing combinatorial diversity (e.g. the bipartite selection strategy described above), or require “stitching” together of individually selected Zfs, thereby sacrificing context-sensitivity (e.g. the parallel selection strategy described above). To date, the only selection strategy developed that does not sacrifice combinatorial diversity or position sensitivity, is the sequential selection method described by Greisman and Pabo (Greisman and Pabo (1997) Science 275:657 and U.S. Pat. No. 6,410,248). However, the generation of a three finger protein by Greisman and Pabo's sequential selection requires the generation and selection of at least two and preferably three Zf libraries for each protein produced (Wolfe et al., (1999) Journal of Molecular Biology 285: 1917). Because these libraries depend upon the results of a previous selection step, each of these libraries must be produced sequentially. As a result, Greisman and Pabo's sequential selection is comparatively labor- and time-intensive, and therefore, less suitable for routine or high-throughput use.

The present invention provides a Zf selection method that allows maximal combinatorial diversity to be maintained and also allows efficient selection of assembled multi-finger polypeptides directly against their given target site. The method, referred to as context-sensitive parallel optimization or CSPO, achieves this goal by combining at least two selection steps. The initial selection utilizes primary Zf libraries in which maximal library diversity is maintained. In the second selection step, full length assembled multi-finger Zf proteins are selected directly against the sequence of interest to identify those multi-finget polypeptides that work in a coordinated fashion to give optimal target site binding. This second step essentially selects for fingers that work well together, thereby accounting for finger position sensitivity. No additional post-selection assembly of individual Zfs (or groups of Zfs) is required. Thus, methods of the present invention avoid problems of position sensitivity and target site overlap suffered by other methods known in the art. Furthermore, only one custom-made library is needed for each new Zf polypeptide to be selected, thus making methods of the present invention simpler and faster to perform than, for example, the sequential selection method.

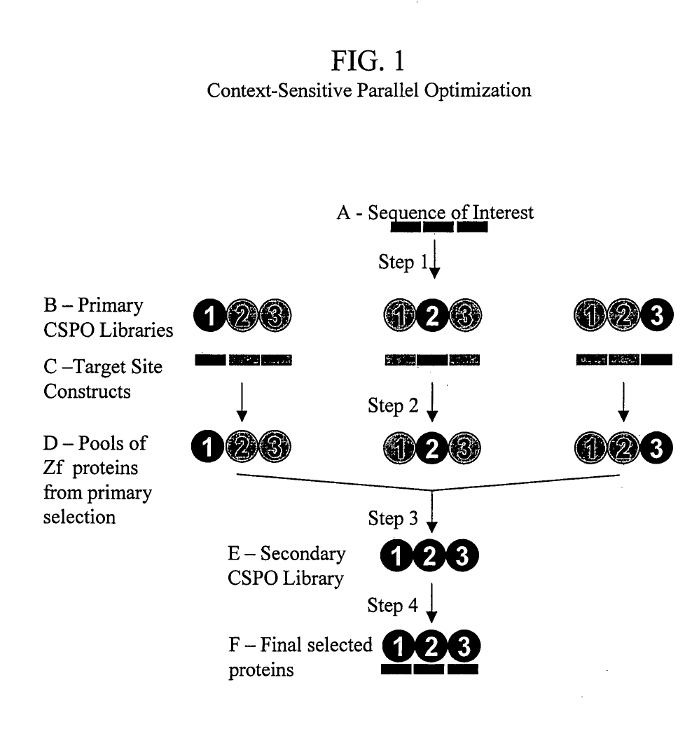

FIG. 1 provides a schematic illustration exemplifying how the CSPO methods of the present invention can be used in the selection of Zf proteins. The selection of an optimized three-finger protein (F) that binds to a sequence of interest (A) is illustrated, although the methods of the invention can also be used to select for proteins having more than three zinc fingers. The sequence of interest (A) comprises 3 “subsites”, each of which is represented as a black box.

Step 1 of FIG. 1 is the primary selection stage, in which “primary CSPO libraries” (B) are selected for binding to “target site constructs” (C). It can be seen that three different primary libraries are required when selecting a three-finger Zf protein. The zinc fingers in each of the three primary libraries (B) are represented as numbered circles. Each of the primary libraries has one zinc finger randomized (as represented by a black circle), and two zinc fingers with a constant “anchor” sequence (as represented by the gray circles). It can be seen that each of the three primary libraries is randomized at a different zinc finger position. Zinc finger position 1 (1) is randomized in the first primary library, zinc finger position (2) is randomized in the second primary library, and zinc finger position 3 (3) is randomized in the third primary library. For the selection of a three finger protein by CSPO, three different primary selections are performed in parallel. Each of the three primary libraries is selected for binding to a different “target site construct” (C). Each target site construct (C) comprises 3 subsites, one of which has the exact sequence of the corresponding subsite in the sequence of interest (as represented by the black box), while the remaining two subsites have a defined “anchor” sequence (as represented by the gray boxes). The sequences of the “anchor fingers” (represented by the gray circles) and the “anchor subsites” (represented by the gray boxes) are chosen specifically so that the anchor fingers bind to the anchor sequences, as is described further below. In primary selection 1, the primary library having zinc finger 1 randomized is selected for binding to the target site construct in which the corresponding subsite has the exact sequence of the sequence of interest. Likewise, with other primary selections, primary libraries are selected against target sites in which the subsite having the exact sequence of the sequence of interest is that which corresponds to the position of the variable finger in the primary library.

FIG. 1 also shows that in step 2, pools of Zf proteins fingers (D) that bind to their corresponding target site with a range of affinities, are identified and selected. In step 3, the nucleic acids encoding these pools of Zf proteins are isolated and recombined randomly to produce a secondary CSPO library (E). In step 4, a secondary selection is performed in which the secondary CSPO library (E) is selected for binding to the exact sequence of interest (A) at high stringency. Thus, final selected Zf proteins (F) are identified which bind with high affinity and specificity to the sequence of interest.

The library and selection methods described herein can be used in conjunction with suitable expression and selection methods known in the art. Preferably bacterial two-hybrid selection or some other prokaryotic or eukaryotic cell-based selection method is used. Use of such cell-based methods has the advantage of selecting for Zf-DNA interactions in living cells and therefore, selecting for polypeptides that will function well in a cellular context. In addition, cell-based selection methods aremore rapid to perform than methods requiring sequential enrichment, such as phage display (Joung et al., (2000) PNAS 97:7382). Methods of the present invention can be used with other commonly used Zf expression/selection systems, such as phage display or polysome display, if desired.

II. Definitions

As used herein, the following terms have the meanings ascribed to them unless specified otherwise.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

The term “zinc finger” or “Zf” refers to a polypeptide comprising a DNA binding domain that is stabilized by zinc. The individual DNA binding domains are typically referred to as “fingers.” A Zf protein has at least one finger, preferably two fingers, three fingers, or six fingers. A Zf protein having two or more Zfs is referred to as a “multi-finger” or “multi-Zf” protein. Each finger typically comprises an approximately 30 amino acid, zinc-chelating, DNA-binding domain. An exemplary motif characterizing one class of these proteins is -Cys-(X) (2-4)-Cys-(X) (12)-His-(X) (3-5)-His (SEQ ID NO:1), where X is any amino acid, which is known as the “C(2)H(2)” class. Studies have demonstrated that a single Zf of this class consists of an alpha helix containing the two invariant histidine residues co-ordinated with zinc along with the two cysteine residues of a single beta turn (see, e.g., Berg and Shi, Science 271:1081-1085 (1996)).

Each finger within a Zf protein binds to from about two to about five base pairs within a DNA sequence. Typically a single Zf within a Zf protein binds to a three or four base pair “subsite” within a DNA sequence. Accordingly, a “subsite” is a DNA sequence that is bound by a single zinc finger. A “multi-subsite” is a DNA sequence that is bound by more than one zinc finger, and comprises at least 4 bp, preferably 6 bp or more. A multi-Zf protein binds at least two, and typically three, four, five, six or more subsites i.e., one for each finger of the protein.

The present invention provides methods for the selection of zinc finger proteins that bind to a desired nucleotide sequence comprising several subsites, which is referred to herein as a “sequence of interest”. A “sequence of interest” is typically located within a “gene of interest.” For example, in one embodiment a “sequence of interest” is a string of consecutive subsites located in the vicinity of the promoter of a gene of interest. In another embodiment, a sequence of interest may be located within the coding region of a gene of interest. However, the “sequence of interest” need not be located in a natural gene, but can be any sequence chosen as the binding site of an engineered zinc finger protein, using the methods of the present invention. For example, in one embodiment, the methods of the present invention can be used to select a Zf protein that binds to a specific sequence in a piece of DNA that has been artificially altered, such as a recombinant DNA molecule in a vector, or a manipulated nucleotide sequence in a transgenic animal.

As used herein the term “target site” refers to any nucleic acid sequence bound by a Zf protein, and encompasses “sequences of interest”. For example, target sites may be artificially created nucleotide sequences that are used solely at certain stages in the selection procedure, and are not the actual “sequence of interest” to which the final selected Zf protein will bind. For example, in the methods of the present invention, artificial DNA constructs known as “target site constructs” are used in the primary selection steps. These “target site constructs” have one target subsite whose sequence is identical to a portion of the sequence of the “sequence of interest” and have one or more other subsites having sequences that are not present in the “sequence of interest” but which are chosen because they bind to the “anchor” fingers in the primary Zf library.

“K_{D}” refers to the dissociation constant for binding of one molecule to another molecule, i.e., the concentration of a molecule (such as a Zf protein), that gives half maximal binding to its binding partner (such as a DNA target sequence) under a given set of conditions. The K_{D} provides a measure of the strength of the interaction between two molecules, or the “affinity” of the interaction between two molecules. Two molecules that bind strongly to each other have a “high affinity” for each other, while molecules that bind weakly to each other have a “low affinity” for each other.

The term “recombinant” when used herein with reference to portions of a nucleic acid or protein, indicates that the nucleic acid comprises two or more sub-sequences that are not found in the same relationship to each other in nature. For instance, a nucleic acid that is recombinantly produced typically has two or more sequences from distinct genes or non-adjacent regions of the same gene, synthetically arranged to make a new nucleic acid sequence encoding a new protein, for example, a DBD from one source and a regulatory or functional region from another source, or a Zf from the native Zif268 protein and a Zf selected from a library. The term “recombination” as used herein, refers to the process of producing a recombinant protein or nucleic acid by standard techniques known to those skilled in the art, and described in, for example, Sambrook et al., Molecular Cloning; A Laboratory Manual 2d ed. (1989). The term “chimeric” as used herein refers to a protein containing at least two component portions or domains which are mutually heterologous in the sense that they do not occur together in precisely the same arrangement in nature. More specifically, the component portions are not found in the same continuous polypeptide sequence or molecule in nature, at least not in the same order or orientation or with the same spacing present in the chimeric protein. Typically the chimeric proteins of the present invention contain a CSPO-selected Zf DNA binding domain and at least one additional domain.

“Nucleotide” refers to a base-sugarphosphate compound. Nucleotides are the monomeric subunits of both types of nucleic acid molecules, RNA and DNA. Nucleotide refers to ribonucleoside triphophates, rATP, rGTP, rUTP and rCTP, and deoxyribonucleoside triphosphates, such as dATP, dGTP, dTTP, and dCTP. “Base” refers to the nitrogen-containing base of a nucleotide, for example adenine (A), cytidine (C), guanine (G), thymine (T), and uracil (U). “Base pair” or “bp” refers to the partnership of bases within the DNA double helix, whereby typically an A on one strand of the double helix is paired with a T on the other strand and a C on one strand of the double helix is paired with a G on the other strand.

“Nucleic acid” refers to deoxyribonucleotides or ribonucleotides and polymers thereof in either single- or double-stranded form. The term encompasses nucleic acids containing known nucleotide analogs or modified backbone residues or linkages, which are synthetic, naturally occurring, and non-naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral-methyl phosphonates, 2-O-methyl ribonucleotides, peptide-nucleic acids (PNAs). Unless otherwise indicated, a particular nucleic acid sequence also implicitly encompasses conservatively modified variants thereof (e.g., degenerate codon substitutions) and complementary sequences, as well as the sequence explicitly indicated. The term nucleic acid is used interchangeably with gene, cDNA and nucleotide. The nucleotide sequences are displayed herein in the conventional 5′ to 3′ orientation.

The terms “polypeptide,” “peptide” and “protein” are used interchangeably herein to refer to a polymer of amino acid residues. The terms apply to amino acid polymers in which one or more amino acid residue is an analog or mimetic of a corresponding naturally occurring amino acid, as well as to naturally occurring amino acid polymers. Polypeptides can be modified, e.g., by the addition of carbohydrate residues to form glycoproteins. The terms “polypeptide,” “peptide” and “protein” include glycoproteins, as well as non-glycoproteins. The polypeptide sequences are displayed herein in the conventional N-terminal to C-terminal orientation.

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, carboxyglutamate, and O-phosphoserine. Amino acid analogs refers to compounds that have the same basic chemical structure as a naturally occurring amino acid, i.e., a carbon that is bound to a hydrogen, a carboxyl group, an amino group, and an R group, e.g., homoserine, norleucine, methionine sulfoxide, methionine, and methyl sulfonium. Such analogs have modified R groups (e.g., norleucine) or modified peptide backbones, but retain the same basic chemical structure as a naturally occurring amino acid. Amino acid mimetics refers to chemical compounds that have a structure that is different from the general chemical structure of an amino acid, but that functions in a manner similar to a naturally occurring amino acid. The terms “amino acid residue” or “residue” refer to a specific amino acid position within a polypeptide or protein.

Degenerate codon substitutions or “doping strategies” may be achieved by generating sequences in which any position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); Rossolini et al., Mol. Cell. Probes 8:91-98 (1994)). Because of the degeneracy of the genetic code, a large number of functionally identical nucleic acids encode any given protein. For instance, the codons GCA, GCC, GCG and GCU all encode the amino acid alanine. Thus, at every position where an alanine is specified by a codon in an amino acid herein, the codon can be altered to any of the corresponding codons described without altering the encoded polypeptide. Such nucleic acid variations are “silent variations,” which are one species of conservatively modified variations. Every nucleic acid sequence herein which encodes a polypeptide also describes every possible silent variation of the nucleic acid. One of skill will recognize that each codon in a nucleic acid (except AUG, which is ordinarily the only codon for methionine, and TGG, which is ordinarily the only codon for tryptophan) can be modified to yield a functionally identical molecule. Accordingly, each silent variation of a nucleic acid which encodes a polypeptide is implicit in each described sequence.

The term “library” as used herein refers to a population of nucleic acid sequences that encode Zf polypeptides. Such “libraries” are used in the present invention to select for and identify Zf polypeptides having desired characteristics from a large and complex pool of Zf polypeptides. Such libraries can be created in cell free systems or within eukaryotic cells, prokaryotic cells or viral particles. The term “primary library” refers to a library that has not been enriched for nucleic acids encoding Zf polypeptides with particular characteristics. The term “secondary library” refers to a library that is enriched for nucleic acids encoding Zf polypeptides with particular characteristics.

The term “randomized” or “randomize” refers to a pool of Zf molecules, or the generation of a pool of Zf molecules, in which one of a multitude of possible amino acids is represented at one or more given “variable” amino acid positions. The term “maximally randomized” as used herein, means that the maximum number of different amino acids are represented at the variable amino acid positions. The maximum number of amino acids that can be represented in any given randomized protein is a function of both the number the of variable positions and the maximal diversity of the library system used. Preferably, the maximum number of different amino acids represented at a given variable amino acid position is 20, 16 or most preferably, 19.

“Specific” or “specific-binding” as used herein, refers to the interaction between a protein and a nucleic acid wherein the protein recognizes and interacts with a defined nucleotide sequence, as opposed to a “non-specific” interaction wherein the protein does not require a defined nucleotide sequence to associate with the nucleic acid molecule (for example, a protein that interacts with the phosphate-sugar backbone of the DNA but not the bases of the nucleotides). The strength of the association between the protein and the nucleic acid molecule can vary significantly between different “binding complexes.” A “binding complex,” as used herein, comprises an association between a sequence of interest, target site or subsite and a Zf binding domain. “Binding complexes” can comprise both weakly-bound Zf proteins and nucleic acids and strongly-bound Zf proteins and nucleic acids. The strength or “affinity” of the association of a Zf with an intended or specified sequence of interest, target site or subsite is expressed in terms of the K_{D}, as defined above.

“Conditions sufficient to form binding complexes” refers to the physical parameters selected for a binding reaction or “incubation” between a nucleic acid and a protein sample that potentially contains an unknown nucleic acid-binding protein, such as, buffer ionic strength, buffer pH, temperature, incubation time, and the concentrations of nucleic acid and protein, where such physical parameters allow nucleic acids to bind to proteins. Such conditions can be “low-stringency conditions”, which are conducive to the formation of “binding complexes” comprising both weakly- and strongly-bound proteins and nucleic acids or “high-stringency conditions”, which are conducive to the formation of “high affinity binding complexes” comprising only strongly-bound proteins and nucleic acids. Low-stringency conditions typically comprise high salt concentration and a temperature ranging between 37° C. and 47° C. When DNA-protein “binding reactions” or “incubations” are performed in vitro, high-stringency conditions typically comprise lower salt concentrations, a temperature of 65° C. or greater, and a detergent, such as sodium dodecylsulfate (SDS) at a concentration ranging from about 0.1% to about 2%. When DNA-protein “binding reactions” or “incubations” are performed within living bacterial cells, the stringency of the binding reaction is controlled, for example, as described by Joung et al. (Joung et al., 2000, Proceedings of the National Academy of Sciences (USA) 97:7382 and US Patent Application No. 20020119498), or as described in Example 8 of the present application.

As used herein the term “selection” has its normal meaning in the art, i.e. selection is the process of detecting or identifying a protein, nucleic acid molecule, cell, or virus having desired properties. Typically the selection methods of the present invention utilize selective media such that only proteins, nucleic acid molecules, cells, or viruses having the desired properties are able to survive, while all other r viruses are killed or inactivated. However, the selection methods of the present invention can also utilize “screening” methods whereby those proteins, nucleic acid molecules, cells, or viruses having the desired properties are detected and picked out from a mixed population without the need for killing or inactivating those proteins nucleic acid molecules, cells, or viruses that do not have the desired properties. For example, when “screening” methods are used, the desired proteins, nucleic acid molecules, cells, or viruses may be identified visually, such as by the detecting the expression of a fluorescent marker, or by any other suitable means.

The term “homologue”, as used herein, refers to a protein or nucleic acid sharing a certain degree of sequence “identity” or sequence “similarity” with a given protein, or the nucleic acid encoding the given protein. The term “percent identity” refers to the percentage of residues in two sequences that are the same when aligned for maximum correspondence. Sequence “similarity” is related to sequence “identity”, but differs in that residues that are not exactly the same as each other, but that are functionally “similar” are taken into consideration.

For example, by way of illustration only, a protein A may be considered to be 100% similar, or share 100% homology with a protein B, even though not all of the amino acids in the two proteins are identical, if the amino acids that differ between the two proteins are “conservative substitutions”.

Those of skill in the art will understand what is meant by “conservative substitutions.” For example, a 3-methyl-histidine residue may be substituted for a histidine residue, a 4-hydroxy-proline residue may be substituted for a proline residue, a 5-hydroxylysine residue may be substituted for a lysine residue, and the like. Furthermore, “conservative substitutions” include substitutions of amino acids with chemically similar amino acids. Conservative substitution tables providing functionally similar amino acids are well known in the art. The following six groups each contain amino acids that are conservative substitutions for one another:

1) Alanine (A), Serine (S), Threonine (T);

2) Aspartic acid (D), Glutamic acid (E);

3) Asparagine (N), Glutamine (Q);

4) Arginine (R), Lysine (K);

5) Isoleucine (I), Leucine (L), Methionine (M), Valine (V); and

6) Phenylalanine (F), Tyrosine (Y), Tryptophan (W).

See also, Creighton (1984) Proteins W.H. Freeman and Co.

Conservative substitutions typically include the substitution of one amino acid for another with similar characteristics such as substitutions within the following groups: valine, glycine; glycine, alanine; valine, isoleucine; aspartic acid, glutamic acid; asparagine, glutamine; serine, threonine; lysine, arginine; and phenylalanine, tyrosine. The non-polar (hydrophobic) amino acids include alanine, leucine, isoleucine, valine, proline, phenylalanine, tryptophan and methionine. The polar neutral amino acids include glycine, serine, threonine, cysteine, tyrosine, asparagine and glutamine. The positively charged (basic) amino acids include arginine, lysine and histidine. The negatively charged (acidic) amino acids include aspartic acid and glutamic acid.

Other conservative substitutions are described by Dayhoff in the Atlas of Protein Sequence and Structure (1988).

There are a number of different algorithms known in the art which can be used to quantify sequence similarity or identity. For instance, polypeptide sequences can be compared using NCBI BLASTp. Alternatively, FASTA, a program in GCG version 6.1. FASTA provides alignments and percent sequence identity of the regions of the best overlap between the query and search sequences (Peterson, 1990). Alternatively, nucleotide sequence similarity or homology or identity can be determined using the “Align” program of Myers and Miller, (“Optimal Alignments in Linear Space”, CABIOS 4, 11-17, 1988) and available at NCBI.

The term “homology” as used herein with respect to a nucleotide or amino acid sequence, is intended to indicate a quantitative measure of the “identity” or “similarity” between two sequences. The percent sequence identity can be calculated as (N_{ref}−N_{dif})*100/N_{ref}, wherein N_{dif} is the total number of non-identical residues in the two sequences when aligned and wherein N_{ref} is the number of residues in one of the sequences. Hence, the DNA sequence AGTCAGTC will have a sequence identity of 75% with the sequence AATCAATC (N_{ref}=8; N_{dif}=2).

Alternatively or additionally, “identity” with respect to sequences refers to the number of positions with identical nucleotides divided by the number of nucleotides in the shorter of the two sequences wherein alignment of the two sequences can be determined in accordance with the Wilbur and Lipman algorithm (Wilbur and Lipman, 1983 PNAS USA 80:726), for instance, using a window size of 20 nucleotides, a word length of 4 nucleotides, and a gap penalty of 4, and computer-assisted analysis and interpretation of the sequence data including alignment can be conveniently performed using commercially available programs (e.g., Intelligenetics™ Suite, Intelligenetics Inc. CA).

When RNA sequences are said to be similar, or have a degree of sequence identity with DNA sequences, thymidine (T) in the DNA sequence is considered equal to uracil (U) in the RNA sequence.

Thus, the term “homolgue” as used herein refers to protein or nucleic sequences sharing either a certain degree of “indentity” or “similarity” with another sequence.

In one embodiment, the homologues of the present invention share at least 70%, 75%, 80%, 85%, 90%, 95%, 96%, 97%, 98%, or 99% sequence similarity with CSPO-selected proteins within their DNA binding domains. Preferably the homologues share at least 80%, 85%, 90%, 95%, 96%, 97%, 98%, or 99% sequence similarity. More preferably the homologues share at least 90%, 95%, 96%, 97%, 98%, or 99% sequence similarity with that of the CSPO-selected proteins within their DNA binding domains. More preferably still, the homologues share 95%, 96%, 97%, 98%, or 99% sequence similarity with the CSPO-selected proteins in their DNA binding domains.

In another embodiment, the homologues of the present invention share at least 70%, 75%, 80%, 85%, 90%, 95%, 96%, 97%, 98%, or 99% sequence identity with CSPO-selected proteins within their DNA binding domains. Preferably the homologues share at least 80%, 85%, 90%, 95%, 96%, 97%, 98%, or 99% sequence identity. More preferably the homologues share at least 90%, 95%, 96%, 97%, 98%, or 99% sequence identity with that of the CSPO-selected proteins within their DNA binding domains. More preferably still, the homologues share 95%, 96%, 97%, 98%, or 99% sequence identity with the CSPO-selected proteins in their DNA binding domains.

The homology to the CSPO-selected proteins need not span the entire length of the CSPO-selected protein. Only the zinc finger DNA binding domain of the CSPO-selected protein need be used in the methods of the present invention. Therefore, the above degrees of homology relate to the amino acid sequence of the zinc finger DNA binding domain of the CSPO-selected protein.

A “functional” homologue or fragment of the CSPO-selected protein, polypeptide or nucleic acid is a protein, polypeptide or nucleic acid whose sequence is not identical to the full-length the CSPO-selected protein, polypeptide or nucleic acid, but yet retains some of the same functions as the full-length the CSPO-selected protein, polypeptide or nucleic acid. In particular, in the methods of the present invention, a “functional homologue” is one that encodes a protein that conforms to a zinc finger consensus sequence, and is capable of binding to DNA. A functional fragment can possess more, fewer, or the same number of residues as the corresponding native molecule, and/or can contain one or more amino acid or nucleotide substitutions. Methods for determining the function of a nucleic acid (e.g., coding function, ability to hybridize to another nucleic acid) are well-in the art. Similarly, methods for determining protein function are well known. For example, the DNA-binding function of a polypeptide can be determined, for example, by filter-binding, electrophoretic mobility-shift, or immunoprecipitation assays. See Ausubel et al., supra. The ability of a protein to interact with another protein can be determined, for example, by co-immunoprecipitation, two-hybrid assays or complementation, both genetic and biochemical. See, for example, Fields et al. (1989) Nature 340:245-246; U.S. Pat. No. 5,585,245 and PCT WO 98/44350.

Further definitions are provided in context below.

III. Construction of Primary Libraries

The CSPO strategy employs construction and/or use of a separate primary library for each Zf position of the multi-finger protein to be generated. For example, if a two-finger protein is required, two primary libraries are produced, the first library having Zf position 1 (the N-terminal Zf) randomized and Zf position 2 held constant as an “anchor” finger. The second primary library would have Zf position 2 (the C-terminal Zf) randomized and Zf position 1 held constant as an “anchor.” Primary Zf libraries with 2, 3, 4, 5, 6, 7, 8, 9 or more Zfs can be produced according to the same scheme, with only one Zf position randomized in each library and the remaining fingers held constant to act as “anchors.”

These primary libraries account for position sensitivity, and are termed “position-sensitive,” because each of the Zfs in the final selected protein is selected using a primary library in which the randomized Zf occurs in the “same position” (relative to the other Zfs) as that selected Zf will occupy in the final multi-Zf product. Thus, the position of the variable Zf (relative to the anchor Zfs) in a given primary library “corresponds” to the position that the Zf selected from that library will occupy in the final selected Zf proteins, relative to the positions of the other Zfs that make up the final selected protein. The use of a separate “position-sensitive” primary library in the selection of each Zf of the final engineered protein advantageously provides for selected proteins in which each Zf has been selected in the same kind of context (with regards to the presence or absence of neighboring fingers, the number of neighboring fingers, and the nature and length of the linkers between each finger) as that Zf will occupy in the final protein. This is in contrast to some previous methods where each finger in a multi-finger protein is selected using the same non-position sensitive primary library (see for Example, Choo et al. (1994). Nature 372: 634-645).

Thus, in one aspect the present provides a method of selecting a zinc finger polypeptide that binds to a sequence interest comprising at least two subsites, said method comprising the steps of:
a) incubating position-sensitive primary libraries with target site constructs under conditions sufficient to form first binding complexes, wherein said primary libraries comprise zinc finger polypeptides having one variable finger and at least one anchor finger, and wherein the target site construct has one subsite with a sequence identical to a subsite of the sequence of interest, and one or more subsites with sequences to which the anchor finger(s) bind,
b) isolating pools comprising nucleic acid sequences encoding polypeptides, wherein said polypeptides comprise the first binding complexes;
c) recombining the pools to produce a secondary library;
d) incubating the secondary library with the sequence of interest under conditions sufficient to form second binding complexes; and
e) isolating nucleic acid sequences encoding zinc finger polypeptides, wherein said polypeptides comprise the second binding complexes.

In another aspect the present invention provides position-sensitive primary libraries, comprising zinc finger polypeptides having one variable finger and at least one anchor finger, wherein the position of the variable finger is the same as the position of the corresponding zinc finger in a multi-finger zinc finger polypeptide.

In the Examples given below, three-finger Zf proteins were selected and thus three separate position sensitive primary libraries were used. In “primary library 1” the N-terminal Zf (Zf 1) was randomized while Zf 2 and Zf 3 were held constant. Accordingly, Zf 1 in primary library 1 is the “variable finger” while Zf 2 and Zf 3 each serve as an “anchor finger” and, randomized Zf 1 in primary library 1 is said to “correspond” to the “finger position” of original Zf 1. In “primary library 2” the middle Zf (Zf 2) was randomized while Zf 1 and Zf 3 were held constant. In “primary library 3” the C-terminal Zf (Zf 3) was randomized while Zf 1 and Zf 2 were held constant.

In a preferred embodiment Zf proteins having from 3-9 zinc fingers are selected using the methods of the present invention, and thus between 3 and 9 different primary libraries are used.

In a preferred embodiment where a 3-finger Zf protein is selected, 3 different primary libraries are used.

In a preferred embodiment where a 4-finger Zf protein is selected, 4 different primary libraries are used.

In a preferred embodiment where a 5-finger Zf protein is selected, 5 different primary libraries are used.

In a preferred embodiment where a 6-finger Zf protein is selected, 6 different primary libraries are used.

In a preferred embodiment where a 7-finger Zf protein is selected, 7 different primary libraries are used.

In a preferred embodiment where an 8-finger Zf protein is selected, 8 different primary libraries are used.

In a preferred embodiment where a 9-finger Zf protein is selected, 9 different primary libraries are used.

Primary libraries, thus described, do not have to be generated anew for each Zf protein to be selected. “Master” primary libraries can be obtained for selection of any Zf protein having the same number of Zfs. For example, any three-finger Zf protein can be selected using the three-finger “master” libraries outlined above.

The constant “anchor” fingers (and the variable fingers to be randomized as described herein) for the primary library can be taken from any natural or synthetic Zf protein known in the art. The only requirement is that a target site for each of the anchor fingers is available (described below). Typically, constant Zfs are made from any suitable C(2)H(2) Zf protein, such as SP-1, SP-1C, TFIIIA, GLI, Tramtrack, YY1, or ZIF268 (see, e.g., Jacobs, EMBO J. 11:4507 (1992); Desjarlais and Berg, Proc. Natl. Acad. Sci. U.S.A. 90:2256-2260 (1993)). More preferably, the “anchor” Zfs are taken from the naturally occurring Zif268 protein, which are well known in the art and bind strongly to their native target sites. More preferably still, for the given invention, the anchor fingers are the previously phage-selected fingers described by Choo et al. (1994, Nature 372: 642). These fingers were synthetically derived from the Zif268 fingers and are not naturally occurring Zfs. The recognition helices (positions −1, +1, +2, +3, +4, +5, and +6) of these phage-selected fingers have the sequences DRSSLTR (SEQ ID NO:2) for finger 1, QGGNLVR (SEQ ID NO:3) for finger 2, and QAATLQR (SEQ ID NO:4) for finger 3, and bind to the DNA subsites GCC (SEQ ID NO:5) for finger 1, GAA (SEQ ID NO:6) for finger 2, and GCA (SEQ ID NO:7) for finger 3, respectively. Preferably, the above phage-selected fingers are used in methods of the present invention because they have lower affinity for their subsites than the naturally occurring Zif268 fingers. Without being bound by theory, it is believed that by using low affinity binding Zfs as anchors, it is possible to enforce greater affinity and specificity on the finger being randomized and selected. When multi-finger proteins are selected using strong “anchor” fingers (for example, Joung et al., (2000) Proceedings of the National Academy of Sciences (USA) 97:7382), the recognition helix sequences of proteins typically selected, yield helices that would be predicted to recognize only two out of the three bases in the target subsite. In contrast, by using weaker or lower affinity “anchor” fingers, it is possible to enforce selection of fingers that would be predicted to recognize all three bases in the subsite.

The “variable” finger in each primary library can be based on any naturally occurring or synthetic Zf protein, as for the “anchor” fingers. Preferably, the variable fingers, like the anchor fingers described above, are based on the previously phage-selected fingers described by Choo et al. (1994, Nature 372: 642). A “variable” finger comprises randomized amino acids at one or more residue positions within or just amino terminal to the beginning of the α-helix. A “variable” finger, as used herein, does not comprise partial or fragmented finger configurations, such as a one-and-a-half finger configuration. Preferably, six amino acid residues in the α-helix of the Zf are randomized. More preferably still, the six amino acid residues at positions −1, +1, +2, +3, +5 and +6 in the α-helix are randomized. Preferably, the variable finger is based upon the Zfs from Zif268. Both variable fingers and anchor fingers can bind to subsites within the target site.

The number of randomized amino acids at a single residue position can be varied up to the maximum limits of the library expression and selection system used. Preferably, all 20 naturally occurring amino acids are represented in any given randomized residue position. Perhaps more frequently, it will be desirable to limit the number of variable amino acids in any given residue position to 19. If cysteine is excluded, the remaining 19 naturally occurring amino acids can be encoded by 24 codons as a result of codon doping schemes wherein some of the codons used encode several amino acids (Wolfe et al., (2001) Structure 9:717). Libraries with 24 codon variations at six variable positions of an α-helix have a diversity of 24⁶ at the nucleotide level. A library of such a size is within the limits of known expression and selection systems, such as the bacterial two-hybrid system and phage display. Thus, in one embodiment, methods of the present invention comprise the use of libraries in which 19 different naturally occurring amino acids are represented at one or more variable residue positions of the α-helix. In this instance, the naturally occurring amino acid cysteine is excluded because cysteine can not readily be incorporated into a 24-codon doping strategy.

In yet another embodiment, 16 naturally occurring amino acids are represented in any given randomized residue position within the α-helix. 16 amino acids can also be encoded by 24 codons using codon-doping strategies (see Joung et al., (2000) Proceedings of the National Academy of Sciences (USA) 97:7382). Thus, as for the 19 amino acid library described above, such a 16 amino acid Zf library also has a diversity of 24⁶. In the embodiment where a 16 amino acid/24 codon library is used, the excluded amino acids are preferably phenylalanine, tryptophan, tyrosine, and cysteine.

The primary libraries described herein can be synthesized using any known randomization strategy (see for example Joung et al., (2000) Proceedings of the National Academy of Sciences (USA) 97:7382). Such strategies are well known to those skilled in the art and include, for example, the use of degenerate oligonucleotides, use of mutagenic cassettes and techniques based on error prone PCR. Methods of cassette mutagenesis are taught by Wolfe et al. (2000) Structure, Volume 7, p 739-750 and Reidhaar-Olson et al. (1988) Science, Volume 241, p 53 to 57. Error-prone PCR uses low-fidelity polymerization conditions to introduce a low level of point mutations randomly over a long sequence. Error prone PCR can be used to mutagenize a mixture of fragments of unknown sequence. Library production and randomization strategies are described in U.S. Pat. No. 6,489,145 (“Method of DNA shuffling”) and U.S. Pat. No. 6,395,547 (“Methods of generating polynucleotides having desired characteristics by iterative selection and recombination”).

Standard recombinant DNA and cloning techniques can be used for library construction and for incorporation of such libraries into appropriate expression and selection systems. Standard recombinant DNA and cloning techniques are well known to those of skill in the art and are described in laboratory text such as, for example, Sambrook et al., Molecular Cloning; A Laboratory Manual 2d ed. (1989), the contents of which are incorporated herein by reference.

For preferred embodiments directed to the selection of three-finger Zf proteins, the primary primary libraries described above, having anchor and variable fingers that are based on the previously phage-selected fingers described by Choo et al. (1994, Nature 372: 642) can be used directly, without the need for generation of further primary libraries. These three primary libraries (named CSPO F1, CSPO F2, and CSPO F3, ATCC accession numbers to be assigned) were deposited with the ATCC on Oct. 23, 2003. These three libraries can be used in the selection of any three-finger protein by CSPO. Similarly, proteins having more three Zfs can be produced by joining together (either covalently or non-covalently) proteins selected using these three CSPO primary libraries.

The recognition helices (positions −1, +1, +2, +3, +4, +5, and +6) of the zinc fingers from which these three libraries are derived are DRSSLTR (SEQ ID NO:2) for finger 1, QGGNLVR (SEQ ID NO:3) for finger 2, and QAATLQR (SEQ ID NO:4) for finger 3. In “primary library 1” (CSPO F1) the N-terminal Zf (Zf 1) is randomized while Zf 2 and Zf 3 have sequences shown (SEQ ID NO; 3 & 4, respectively). In “primary library 2” (CSPO F2) the middle Zf (Zf 2) is randomized while Zf 1 and Zf 3 have the sequences shown (SEQ ID NO; 2 & 4, respectively). In “primary library 3” (CSPO F3) the C-terminal Zf (Zf 3) is randomized while Zf 1 and Zf 2 have the sequences shown (SEQ ID NO; 2 & 3, respectively).

IV. Choice of the “Sequence of Interest” and Production of Target Site Constructs

In a preferred embodiment, the sequence of interest is chosen from a genomic “address” or location that is within or proximal to, for example, a “gene of interest”, such that the sequence is statistically unique enough to occur only once in the genome. This ability to specify a unique sequence is a function of the length of the target site and the size of the genome or other desired substrate (such as a nucleic acid vector, for example). For example, assuming random base distribution, a unique 16 bp sequence will occur only once in 4.3×10⁹ bp, thus a 16 bp sequence should be sufficient to specify a unique address within 4.3×10⁹ bp of sequence. Similarly, an 18 bp address would enable sequence specific targeting within 6.8×10¹⁰ bp of DNA. The unique sequence of interest selected can be located anywhere within or proximal to the gene of interest. Wherein the ultimate aim is to generate a synthetic transcription factor to regulate expression of the gene of interest, it is preferable that the chosen sequence of interest is within the general vicinity of the promoter and in a region where chromatin architecture will not impede binding of the Zf protein to the DNA (see for example, Liu et al., (2001) Journal of Biological Chemistry 276:11323).

A sequence of interest can be located in any gene or other nucleic acid sequence (such as a vector). For example, a sequence of interest may be in a “therapeutic gene” or “therapeutically useful gene.” “Therapeutic genes” are genes where there could be some therapeutic benefit obtained from up- or down-regulating expression, or otherwise altering the structure or function, of that gene.

Once the desired sequence of interest has been chosen, “target site constructs” for use in selection assays can be produced. The CSPO strategy employs construction and/or use of a separate “target site construct” for each subsite within the entire sequence of interest. For example, if a 6 bp (2 subsite) sequence of interest is chosen, two target site constructs are produced. For example, in the first target site construct subsite 1 (the 5′ subsite) would be derived from the sequence of interest, and subsite 2 (the 3′ subsite) would have a defined “anchor” sequence. In the second target site construct subsite 2 (the 3′ subsite) would be derived from the sequence of interest, and subsite 1 would have a defined “anchor” sequence. DNA target sites with 2, 3, 4, 5, 6 or more subsites can be produced according to the same scheme, with only one subsite having the sequence of the gene of interest and the remaining subsites having the defined “anchor” sequences which bind to the “anchor” fingers in the primary libraries. These target site constructs are referred to as “position sensitive” because the subsites having the sequence of the gene of interest are located at the same position relative to the other subsites, as occurs in the true target site within the gene of interest.

Furthermore, in the primary selection each “position-sensitive” target site construct is incubated with its corresponding “position-sensitive” primary library. For example, if a three zinc finger polypeptide is to be selected for binding to a three subsite target-site construct, three different primary libraries and three different target site constructs are used. To select the middle finger of the three finger protein, a primary library have the middle finger varied is selected for binding to a target site construct in which the middle subsite has the sequence of interest.

In a preferred embodiment, these target site constructs would be positioned upstream of a test promoter for use in the bacterial two-hybrid system (Joung et al., 2000, Proceedings of the National Academy of Sciences (USA) 97:7382 and US Patent Application No. 20020119498).

In preferred embodiments where primary CSPO libraries CSPO F1, CSPO F2, and CSPO F3 (ATCC accession numbers to be assigned) are used, the target site constructs to be used in selection are designed accordingly, such that only one subsite has the sequence of the gene of interest and the other subsites are those to which the constant anchor fingers bind. Thus, when using primary library 1 (CSPO F1) which has Zf 1 varied, subsites 2 and 3 (to which anchor fingers 2 and 3 bind) should have the sequence GAA (SEQ ID NO:6) and GCA (SEQ ID NO:7), respectively while subsite 1 should have the sequence of the gene of interest. Similarly, when using primary library 2 (CSPO F2) which has Zf 2 varied, subsites 1 and 3 (to which anchor fingers 1 and 3 bind) should have the sequence GCC (SEQ ID NO:5) and GCA (SEQ ID NO:7), respectively while subsite 2 should have the sequence of the gene of interest. Accordingly, when using primary library 3 (CSPO F3) which has Zf 3 varied, subsites 1 and 2 (to which anchor fingers 1 and 2 bind) should have the sequence GCC (SEQ ID NO:5)and GAA (SEQ ID NO:6), respectively, while target subsite 3 should have the sequence of the gene of interest.

Whatever sequence of interest used, the target site constructs can be synthesized readily using standard molecular biology techniques (for example using restriction digestion of vector DNA, PCR, or automated nucleic acid synthesis). Such techniques are well known to those skilled in the art and are described in many laboratory texts such as, for example Sambrook et al., Molecular Cloning, A Laboratory Manual 2d ed. (1989).

V. Polypeptide Library Expression and Selection System

As with other Zf selection strategies, CSPO requires an expression system to enable production of the library-encoded Zf proteins, a mechanism for assaying the binding of the library-encoded Zf proteins to the DNA targets, (the target site constructs and/or sequence of interest), and a means of selecting from the library those Zfs with the desired binding characteristics.

The primary libraries described above can be expressed using any of a variety of protein expression systems known in the art, such as phage display, polysome display, in vitro. transcription/translation, or expression in eukaryotic or prokaryotic cells. It would be routine for one skilled in the art to incorporate such a library into such an expression system.

Likewise, there are many methods known in the art that would allow the binding of the library-encoded Zf proteins to their DNA targets, to be measured, such as by phage display, bacterial two-hybrid and ribosome display. Any known protein expression system and any known protein-DNA binding assay could be combined and used to identify library-encoded Zf proteins having the desired binding characteristics.

In a preferred embodiment, a eukaryotic or prokaryotic cell-based expression and selection system is used. Use of such a cell-based system advantageously provides for the selection and expression of proteins inside living cells, thus the Zf proteins identified are likely to function well in a cellular context.

In a more preferred embodiment, a bacterial “two-hybrid” system is used to express and select the Zfs of the present invention. The bacterial two-hybrid selection method has an additional advantage, in that the library protein expression and the DNA binding “assay” occur within the same cells, thus there is no separate DNA binding assay to set up.

Methods for the use of the bacterial two-hybrid system to express and select Zf proteins are described in Joung et al., 2000, Proceedings of the National Academy of Sciences (USA) 97:7382 and US Patent Application No. 20020119498, the contents of which are incorporated herein by reference. Briefly, in the bacterial two-hybrid system, the zinc finger library (such as a CSPO primary library) is expressed in a bacterial “selection strain” bearing the target site sequence upstream of a weak promoter controlling expression of the histidine 3. (HIS3) reporter gene. Expression of the HIS3 gene only occurs in cells in which the zinc finger protein expressed by the library binds to the target site sequence. Thus, bacterial cells expressing zinc finger proteins that bind to their target site are selected by their ability to grow on HIS-selective media.

Whichever expression and DNA-binding system is used, a key aspect of the present invention is that a separate primary selection is performed for each “Zf/subsite pair” i.e., if the aim is to select a two finger protein that binds to a given 6 bp sequence of interest, two parallel selections are performed, one for each Zf/subsite pair. For example, in the scheme described above, in primary selection 1, primary library 1 is expressed and selected for binding to DNA target site 1 i.e., primary library 1 and DNA target site construct 1 comprise a Zf/subsite pair. Similarly, in primary selection 2, primary library 2 is expressed and selected for binding to DNA target site construct 2. It follows that, if the aim is to select a three finger protein that binds to a given 9 bp sequence of interest, three parallel selections are performed, one for each Zf/subsite pair. Similarly, if the aim is to select a six finger protein that binds to a given 18 bp sequence of interest, six parallel selections are performed.

In a preferred embodiment, the stringency of each of the primary selections should be low, such that each selection yields a pool of Zf proteins with target binding affinities that range from low to high. The rationale for this low stringency selection is that there should be no bias towards Zfs that bind tightly to their target subsite at the primary selection stage, because Zfs so identified may not bind tightly to their target subsite in the context of the Zfs selected against the other subsites that make up the full sequence of interest. Zfs that bind tightly in the context of the “anchor” fingers may not bind tightly in the context of the other fingers required for binding to the sequence of interest. Mechanisms for controlling the stringency of DNA binding reactions are known to those of skill in the art and any such mechanism can be used.

VI. Construction of Secondary Partially Optimized Library

The primary selection methods described above will yield a separate “pool” of candidate Zf proteins for each “Zf/subsite” pair. A key aspect of the CSPO strategy is that these “pools” can be recombined to produce a secondary library comprising variants that harbor fingers which have been partially optimized for binding to a desired subsite. For example, such a secondary library can comprise a range of multi-finger proteins composed of random combinations of the pools of fingers selected from the randomized fingers of the primary library. Thus, the secondary library can comprise multi-finger proteins that, unlike the primary library, can potentially vary at all finger positions of the multi-finger proteins. Furthermore, the secondary library can comprise fingers with a range of binding affinities and specificities for their target subsite(s). The secondary library can then be used in a secondary selection, which is preferably conducted under conditions of high-stringency, to produce a multi-Zf polypeptide that binds with high affinity and specificity to the sequence of interest. Preferably, a new secondary library is synthesized for each new multi-finger protein to be produced.

The individual “pools” derived from the individual primary selections can be recombined using any one of a number of recombination techniques known in the art, such as described in, for example, Sambrook et al., Molecular Cloning; A Laboratory Manual 2d ed. (1989). A variety of in vitro DNA recombination methods exist. Examples include those described in described in U.S. Pat. No. 6,489,145 (“Method of DNA shuffling”), U.S. Pat. No. 6,395,547 (“Methods of generating polynucleotides having desired characteristics by iterative selection and recombination”), U.S. Pat. No. 5,605,793 (“Methods for in vitro recombination”), U.S. Pat. No. 5,965,408 (“Method of DNA reassembly by interrupting synthesis”), and in Horton et al., 1995 Molecular Biotechnology, Volume 3, p 93-99 (“PCR-mediated recombination and mutagenesis—SOEing together tailor-made genes”). Generally, recombination methods depend on a step of making fragments, and a step of recombining the fragments. For example, U.S. Pat. No. 5,605,793 generally relies on fragmentation of double stranded DNA molecules by DNase I. U.S. Pat. No. 5,965,408 generally relies on the annealing of relatively short random primers to target genes and extending them with DNA polymerase. Each of these disclosures relies on polymerase chain reaction (PCR)-like thermocycling of fragments in the presence of DNA polymerase to recombine the fragments.

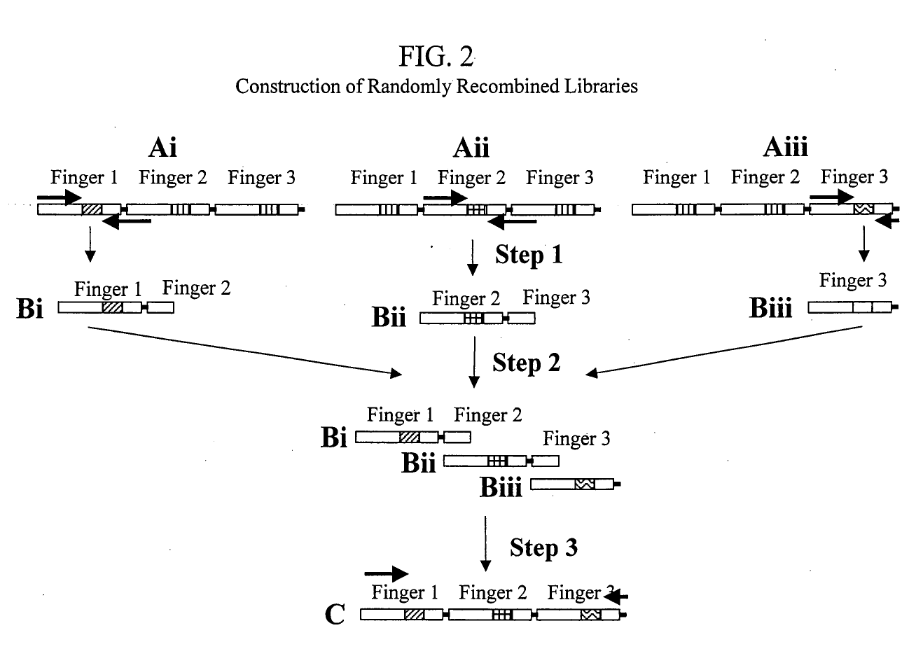

Preferably, the individual “pools” derived from the individual primary selections are recombined using a PCR-mediated recombination method. More preferably still, the individual “pools” derived from the individual primary selections are recombined using the PCR-mediated recombination method outlined in FIG. 2. In FIG. 2, the pools of three-finger proteins selected from three different primary libraries in three distinct primary selections, are represented as Ai, Aii, and Aiii. In step 1, PCR using finger specific primers is used to amplify each selected finger, in some cases along with a portion of a neighboring “anchor” finger. Thus, in pool Ai, PCR primers (shown as heavy arrows) are used to amplify zinc finger 1 (the “variable” finger) along with a portion of “anchor” finger 2. In pool Aii, PCR primers (shown as heavy arrows) are used to amplify zinc finger 2 (the “variable” finger) along with a portion of “anchor” finger 3. In pool Aiii, PCR primers (shown as heavy arrows) are used to amplify zinc finger 3 (the “variable” finger). In the situation shown in FIG. 2, there is no need to amplify a portion of a neighboring “anchor” finger 2 from pool Aiii, because the three PCR amplified pools (Bi, Bii, and Biii) contain sufficient overlapping sequences. Thus, the three PCR amplified pools, Bi, Bii, and Biii, can be randomly recombined by overlap-mediated PCR (step 2), and amplified using end primers (step 3) to generate a pool or randomly recombined Zf proteins that is the partially optimized secondary library (C).

VII. Secondary Selection

For each sequence of interest-specific multi-Zf protein to be produced, a single high-stringency secondary selection is preferred. In this selection, a partially optimized secondary library (such as described above) is selection against a target construct that comprises the sequence of interest (note that there no anchor sites in this sequence). Thus, in the secondary selection, full-length assembled Zfs that bind to the sequence of interest can be identified. This is a key aspect of the present invention, as it means that there is no need to perform any post-selection assembly of individual Zfs or groups of Zfs. Such post-selection assembly is a common feature of other Zf selection methods. Post-selection assembly often introduces an uncontrollable element into the production of multi-finger proteins, as there is a possibility that the individually selected fingers will not function as predicted when assembled into the final multi-finger protein. Methods of the present invention advantageously allow for secondary selection of fully assembled Zfs, thereby accounting for potential finger position sensitivity.

Secondary selection is preformed essentially as described for above for the primary selection. In a preferred embodiment, the secondary selection is performed at high-stringency in order to isolate proteins that bind to their sequence of interest with high affinity and specificity. Mechanisms for controlling the stringency of selection reactions are known to those of skill in the art and any such mechanism can be used.

VIII. Characterization of CSPO Selected Proteins

Recombinant Zf proteins identified using methods of the present invention can be further characterized after selection to ensure that they have the desired characteristics for their chosen use. Furthermore, the selected proteins can be tested using a different strategy than that used in the original selection, thereby controlling for the possibility of spurious or artifactual interactions specific to the selection system. For example, Zfs selected using a bacterial two-hybrid or phage-display system can be assayed for binding to sequence of interest using an electrophoretic mobility shift assay or “EMSA” (Buratowski & Chodosh, in Current Protocols in Molecular Biology pp. 12.2.1-12.2.7). Equally, any other DNA binding assay known in the art could be used to verify the DNA binding properties of the selected protein.

Preferably, calculations of binding affinity and specificity are also made. This can be done by a variety of methods. The affinity with which the selected Zf protein binds to the sequence of interest can be measured and quantified in terms of its K_{D}. Any assay system can be used, as long is it gives an accurate measurement of the actual K_{D} of the Zf protein. In one embodiment, the K_{D} for the binding of a Zf protein to its target is measured using an EMSA

In a preferred embodiment, EMSA is used to determine the K_{D} for binding of the selected Zf protein both to the sequence of interest (i.e. the specific K_{D}) and to non-specific DNA (i.e. the non-specific K_{D}). Any suitable non-specific or “competitor” double stranded DNA known in the art can be used. Preferably, calf thymus DNA or human placental DNA is used. The ratio of the non-specific K_{D} to the specific K_{D} is the specificity ratio. Zfs that bind with high specificity have a high specificity ratio. This measurement is very useful in deciding which of a group of selected Zfs should be used for a given purpose. For example, use of Zfs in vivo requires not only high affinity binding but also high-specificity binding. In a preferred embodiment, Zfs isolated using methods of the present invention have binding specificities higher than Zfs selected using other selection strategies (such as parallel selection and bipartite selection), and even more preferably, comparable or superior to those of naturally occurring multi-finger proteins, such as Zif268.

IX. Construction of Chimeric CSPO Selected Proteins.

The ultimate aim of producing a custom-designed Zf DNA binding domain by CSPO is to obtain a Zf protein that can be used to perform a function. The Zf DBD can be used alone, for example to bind to a specific site on a gene and thus block binding of other DNA-binding domains. However, in a preferred embodiment, the Zf will be used in the construction of a “chimeric CSPO-selected Zf protein” containing a Zf DNA binding domain and an additional domain having some desired specific function (e.g. gene activation) or enzymatic activity i.e., a “functional domain.”

Chimeric CSPO-selected proteins (i.e. recombinant proteins having a CSPO-selected Zf DNA binding domain and an additional functional domain) can be used to perform any function where it is desired to target, for example, some specific enzymatic activity to a specific DNA sequence, as well as any of the functions already described for other types of synthetic or engineered zinc finger molecules. CSPO-selected Zf DNA binding domains, can be used in the construction of chimeric proteins useful for the treatment of disease (see, for example, U.S. patent application 2002/0160940 A1, and U.S. Pat. Nos. 6,511,808, 6,013,453 and 6,007,988, and International patent application WO 02057308 A2), or for otherwise altering the structure or function of a given gene in vivo. The chimeric CSPO-selected Zf proteins of the present invention are also useful as research tools, for example, in performing either in vivo or in vitro functional genomics studies (see, for example, U.S. Pat. No. 6,503,717 and U.S. patent application 2002/0164575 A1).

To generate a functional recombinant protein, the CSPO-selected Zf DNA binding domain will typically be fused to at least one “functional” domain. Fusing functional domains to synthetic Zf proteins to form functional transcription factors involves only routine molecular biology techniques which are commonly practiced by those of skill in the art, see for example, U.S. Pat. Nos. 6,511,808, 6,013,453, 6,007,988, 6,503,717 and U.S. patent application 2002/0160940 A1).

Functional domains can be associated with the CSPO-selected Zf domain at any suitable position, including the C- or N-terminus of the Zf protein. Suitable “functional” domains for addition to the CSPO-selected protein made using the methods of the invention are described in U.S. Pat. Nos. 6,511,808, 6,013,453, 6,007,988, and 6,503,717 and U.S. patent application 2002/0160940 A1.

In one embodiment, the functional domain is a nuclear localization domain which provides for the protein to be translocated to the nucleus. Several nuclear localization sequences (NLS) are known, and any suitable NLS can be used. For example, many NLSs have a plurality of basic amino acids, referred to as a bipartite basic repeats (reviewed in Garcia-Bustos et al, Biochimica et Biophysica Acta (1991) 1071, 83-101). An NLS containing bipartite basic repeats can be placed in any portion of chimeric protein and results in the chimeric protein being localized inside the nucleus. It is preferred that a nuclear localization domain is routinely incorporated into the final chimeric protein, as the ultimate functions of the chimeric proteins of the present invention will generally require the proteins to be localized in the nucleus. However, it may not be necessary to add a separate nuclear localization domain in cases where the CSPO-selected Zf domain itself, or another functional domain within the final chimeric protein, has intrinsic nuclear translocation function.

In another embodiment, the functional domain is a transcriptional activation domain such that the chimeric protein can be used to activate transcription of the gene of interest. Any transcriptional activation domain known in the art can be used, such as for example, the VP16 domain form herpes simplex virus (Sadowski et al. (1988) Nature, Volume 335, p 563-564) or the p65 domain from the cellular transcription factor NF-κB (Ruben et al. (1991) Science, Volume 251, p 1490-1493).

In yet another embodiment, the functional domain is a transcriptional repression domain such that the chimeric protein can be used to repress transcription of the gene of interest. Any transcriptional repression domain known in the art can be used, such as for example, the KRAB domain found in many naturally occurring KRAB proteins (Thiesen et al. (1991) Nucleic Acids Research, Volume 19 p 3996).

In a further embodiment, the functional domain is a DNA modification domain such as a methyltransferase (or methylase) domain, a de-methylation domain, an acteylation domain, or a deacteylation domain. Many such domains are known in the art and any such domain can be used, depending on the desired function of the resultant chimeric protein. For example, it has been shown that a DNA methylation domain can be fused to a Zf protein and used for targeted methylation of a specific DNA sequence (Xu et al., (1997) Nature Genetics, Volume 17, p 376-378). The state of methylation of a gene affects its expression and regulation, and furthermore, there are several diseases associated with defects in DNA methylation.

In a still further embodiment the functional domain is a chromatin modification domain such as a histone acteylase or histone de-acetylase (or HDAC) domain. Many such domains are known in the art and any such domain can be used, depending on the desired function of the resultant chimeric protein. Histone deacetylases (such as HDAC1 and HDAC2) are involved in gene repression. Therefore, by targeting HDAC activity to a specific gene of interest using a CSPO-selected Zf protein, the expression of the gene of interest can be repressed.

In an alternative embodiment, the functional domain is a nuclease domain, such as a restriction endonuclease (or restriction enzyme) domain. The DNA cleavage activity of a nuclease enzyme can be targeted to a specific target sequence by fusing it to an appropriate CSPO-selected Zf DNA binding domain. In this way, sequence specific chimeric restriction enzyme can be produced. Several nuclease domains are known in the art and any suitable nuclease domain can be used. For example, the endonuclease domain of the type II restriction endonuclease FokI can be used, as taught be Kim et al. ((1996) Proceedings of the National Academy of Sciences, Volume 6, p1156-60). Such chimeric endonucleases can be used in any situation where cleavage of a specific DNA sequence is desired, such as in laboratory procedures for the construction of recombinant DNA molecules, or in producing double-stranded DNA breaks in genomic DNA in order to promote homologous recombination (Kim et al. (1996) Proceedings of the National Academy of Sciences, Volume 6, p1156-60; Bibikova et al. (2001) Molecular & Cellular Biology, Volume 21, p 289-297; Porteus & Baltimore (2003) Science, Volume 300, p763)).

In a further alternative embodiment, the functional domain is an integrase domain, such that the chimeric protein can be used to insert exogenous DNA at a specific location in, for example, the human genome.

Other suitable functional domains include silencer domains, nuclear hormone receptors, resolvase domains oncogene transcription factors (e.g., myc, jun, fos, myb, max, mad, rel, ets, bcl, myb, mos family members etc.), kinases, phosphatases, and any other proteins that modify the structure of DNA and/or the expression of genes. Suitable kinase domains, from kinases involved in transcription regulation are reviewed in Davis, Mol. Reprod. Dev. 42:459-67 (1995). Suitable phosphatase domains are reviewed in, for example, Schonthal & Semin, Cancer Biol. 6:239-48 (1995).

Fusions of CSPO-selected Zfs to functional domains can be performed by standard recombinant DNA techniques well known to those skilled in the art, and as are described in, for example, basic laboratory texts such as Sambrook et al., Molecular Cloning; A Laboratory Manual 2d ed. (1989), and in U.S. Pat. Nos. 6,511,808, 6,013,453, 6,007,988, and 6,503,717 and U.S. patent application 2002/0160940 A1.

In one embodiment, the DNA binding domain used to form the recombinant proteins of the present invention is the exact monomeric CSPO-selected protein that has been selected.

In other embodiments, two or more CSPO-selected Zf proteins are linked together to produce the final DNA binding domain. The linkage of two or more selected CSPO-selected proteins may be performed by covalent or non-covalent means. In the case of covalent linkage CSPO-selected proteins can be covalently linked together using an amino acid linker (see, for example, U.S. patent application 2002/0160940 A1, and International applications WO 02099084A2 and WO 0153480 A1). This linker may be any string of amino acids desired. In one embodiment the linker is a canonical TGEKP linker. Whatever linkers are used standard recombinant DNA techniques (such as described in, for example, Sambrook et al., Molecular Cloning; A Laboratory Manual 2d ed. (1989)) are used to produce such linked proteins.

In the case of non-covalent linkage, two or more CSPO-selected proteins may be multimerized i.e, two or more folded CSPO-selected protein “subunits” may associate with each other by non-covalent interactions to form a “multi-subunit protein assembly” or “multimeric complex”. Where only two CSPO-selected proteins are non-covalently linked, the proteins are said to be dimerized. In one embodiment two identical CSPO-selected proteins may be linked to form a homo-dimer. In an alternative embodiment two different CSPO-selected proteins may be linked to form a hetero-dimer. For example, a six-finger protein may be produced by dimerization of two three-finger proteins, or an eight-finger protein may be produced by dimerization of two four-finger proteins. The production of multimers or dimers can be performed by fusing “multimerization” or “dimerization domains” to the zinc finger proteins to be joined. Any suitable method for fusing protein domains or producing chimeric proteins can be used. For example, in one embodiment, the DNA encoding the zinc finger protein is fused to the DNA encoding the multimerization domain using standard recombinant DNA technqiues (as described in, for Example, Sambrook et al., Molecular Cloning; A Laboratory Manual 2d ed. (1989).

Suitable multimerization or dimerization domains can be selected from any protein that is known to exists as a multimer or dimer, or any protein known to possess such multimerization or dimerization activity. Examples, of suitable domains include the dimerization element of Gal4, leucine zipper domains, STAT protein N-terminal domains, FK506 binding proteins, and randomized peptides selected for Zf dimerization activity (see, e.g., Bryan et al. (1999) PNAS 96:9568) Pomerantz et al., Biochemistry 37: 965-970 (1998), Wolfe et al., Structure 8: 739-750 (2000), O'Shea, Science 254: 539 (1991), Barahmand-Pour et al., Curr. Top. Microbiol. Immunol. 211:121-128 (1996); Klemm et al., Annu. Rev. Immunol. 16:569-592 (1998); Ho et al., Nature 382:822-826 (1996)). Furthermore, some zinc finger proteins themselves have dimerization activity. For example, the zinc fingers from the transcription factor Ikaros have dimerization activity (McCarty et al., Molecular Cell 11: 459-470 (2003). Thus, if the selected Zf proteins themselves have dimerization function there will be no need to fuse an additional dimerization domain to these proteins. In certain embodiments, “conditional” multimerization of dimerization” technology can be used. For example, this can be accomplished using FK506 and FKBP interactions. FK506 binding domains are attached to the proteins to be dimerized. These proteins will remain apart in the absence of a dimerizer. Upon addition of a dimerizer, such as the synthetic ligand FK1012, the two proteins will fuse.

In embodiments where the CSPO-selected proteins are used in the generation of chimeric endonuclease it is preferred that the chimeric protein possesses a dimerization domain as endonucleases are believed to function as dimers. Any suitable dimerization domain may be used. In one embodiment the endonuclease domain itself possesses dimerization activity. For example, the nuclease domain of Fok I which has intrinsic dimerization activity can be used (Kim et al. (1996, PNAS Vol 93, p 1156-1160).

X. Expression of CSPO Selected Proteins.

In order to use the recombinant CSPO-selected proteins of the present invention, it will normally be necessary to express the recombinant CSPO-selected proteins from the nucleic acid that encodes them. This can be performed in a variety of ways. For example, the nucleic acid encoding the CSPO-selected Zf protein is typically cloned into an intermediate. vector for transformation into prokaryotic or eukaryotic cells for replication and/or expression. Intermediate vectors are typically prokaryote vectors, e.g., plasmids, or shuttle vectors, or insect vectors, for storage or manipulation of the nucleic acid encoding the CSPO-selected Zf protein or production of protein. The nucleic acid encoding the CSPO-selected Zf protein is also typically cloned into an expression vector, for administration to a plant cell, animal cell, preferably a mammalian cell or a human cell, fungal cell, bacterial cell, or protozoal cell.

To obtain expression of a cloned gene or nucleic acid, the CSPO-selected Zf protein is typically subcloned into an expression vector that contains a promoter to direct transcription. Suitable bacterial and eukaryotic promoters are well known in the art and described, e.g., in Sambrook et al., Molecular Cloning, A Laboratory Manual (2nd ed. 1989); Kriegler, Gene Transfer and Expression: A Laboratory Manual (1990); and Current Protocols in Molecular Biology (Ausubel et al., eds., 1994). Bacterial expression systems for expressing the CSPO-selected Zf protein are available in, e.g., E. coli, Bacillus sp., and Salmonella (Palva et al., Gene 22:229-235 (1983)). Kits for such expression systems are commercially available. Eukaryotic expression systems for mammalian cells, yeast, and insect cells are well known in the art and are also commercially available.

The promoter used to direct expression of the CSPO-selected Zf protein nucleic acid depends on the particular application. For example, a strong constitutive promoter is typically used for expression and purification of the CSPO-selected Zf protein. In contrast, when the CSPO-selected Zf protein is to be administered in vivo for gene regulation, either a constitutive or an inducible promoter is used, depending on the particular use of the CSPO-selected Zf protein. In addition, a preferred promoter for administration of the CSPO-selected Zf protein can be a weak promoter, such as HSV TK or a promoter having similar activity. The promoter typically can also include elements that are responsive to transactivation, e.g., hypoxia response elements, Gal4 response elements, lac repressor response element, and small molecule control systems such as tet-regulated systems and the RU-486 system (see, e.g., Gossen & Bujard, PNAS 89:5547 (1992); Oligino et al., Gene Ther. 5:491-496 (1998); Wang et al., Gene Ther. 4:432-441 (1997); Neering et al., Blood 88:1147-1155 (1996); and Rendahl et al., Nat. Biotechnol. 16:757-761 (1998)).

In addition to the promoter, the expression vector typically contains a transcription unit or expression cassette that contains all the additional elements required for the expression of the nucleic acid in host cells, either prokaryotic or eukaryotic. A typical expression cassette thus contains a promoter operably linked, e.g., to the nucleic acid sequence encoding the Zf protein signals required, e.g., for efficient polyadenylation of the transcript, transcriptional termination, ribosome binding sites, or translation termination. Additional elements of the cassette may include, e.g., enhancers, and heterologous spliced intronic signals.

The particular expression vector used to transport the genetic information into the cell is selected with regard to the intended use of the CSPO-selected Zf protein, e.g., expression in plants, animals, bacteria, fungus, protozoa etc. (see expression vectors described below and in the Example section). Standard bacterial expression vectors include plasmids such as pBR322 based plasmids, pSKF, pET23D, and commercially available fusion expression systems such as GST and LacZ. A preferred fusion protein is the maltose binding protein, “MBP.” Such fusion proteins are used for purification of the CSPO-selected Zf protein. Epitope tags can also be added to recombinant proteins to provide convenient methods of isolation, for monitoring expression, and for monitoring cellular and subcellular localization, e.g., c-myc or FLAG.

Expression vectors containing regulatory elements from eukaryotic viruses are often used in eukaryotic expression vectors, e.g., SV40 vectors, papilloma virus vectors, and vectors derived from Epstein-Barr virus. Other exemplary eukaryotic vectors include pMSG, pAV009/A+, pMTO10/A+, pMAMneo-5, baculovirus pDSVE, and any other vector allowing expression of proteins under the direction of the SV40 early promoter, SV40 late promoter, metallothionein promoter, murine mammary tumor virus promoter, Rous sarcoma virus promoter, polyhedrin promoter, or other promoters shown effective for expression in eukaryotic cells.

Some expression systems have markers for selection of stably transfected cell lines such as thymidine kinase, hygromycin B phosphotransferase, and dihydrofolate reductase. High yield expression systems are also suitable, such as using a baculovirus vector in insect cells, with the CSPO-selected Zf protein encoding sequence under the direction of the polyhedrin promoter or other strong baculovirus promoters.

The elements that are typically included in expression vectors also include a replicon that functions in E. coli, a gene encoding antibiotic resistance to permit selection of bacteria that harbor recombinant plasmids, and unique restriction sites in nonessential regions of the plasmid to allow insertion of recombinant sequences.

Standard transfection methods are used to produce bacterial, mammalian, yeast or insect cell lines that express large quantities of protein, which are then purified using standard techniques (see, e.g., Colley et al., J. Biol. Chem. 264:17619-17622 (1989); Guide to Protein Purification, in Methods in Enzymology, vol. 182 (Deutscher, ed., 1990)). Transformation of eukaryotic and prokaryotic cells are performed according to standard techniques (see, e.g., Morrison, J. Bact. 132:349-351 (1977); Clark-Curtiss & Curtiss, Methods in Enzymology 101:347-362 (Wu et al., eds, 1983).

Any of the well known procedures for introducing foreign nucleotide sequences into host cells may be used. These include the use of calcium phosphate transfection, polybrene, protoplast fusion, electroporation, liposomes, microinjection, naked DNA, plasmid vectors, viral vectors, both episomal and integrative, and any of the other well known methods for introducing cloned genomic DNA, cDNA, synthetic DNA or other foreign genetic material into a host cell (see, e.g., Sambrook et al., supra). It is only necessary that the particular genetic engineering procedure used be capable of successfully introducing at least one gene into the host cell capable of expressing the protein of choice.

XI. Assays for Determining Regulation of Gene Expression by CSPO Selected Proteins.

A variety of assays can be used to determine the level of gene expression regulation by the CSPO-selected Zf proteins, see for example U.S. Pat. No. 6,453,242. The activity of a particular CSPO-selected Zf protein can be assessed using a variety of in vitro and in vivo assays, by measuring, e.g., protein or mRNA levels, product levels, enzyme activity, tumor growth; transcriptional activation or repression of a reporter gene; second messenger levels (e.g., cGMP, cAMP, IP3, DAG, Ca.sup.2+); cytokine and hormone production levels; and neovascularization, using, e.g., immunoassays (e.g., ELISA and immunohistochemical assays with antibodies), hybridization assays (e.g., RNase protection, northerns, in situ hybridization, oligonucleotide array studies), colorimetric assays, amplification assays, enzyme activity assays, tumor growth assays, phenotypic assays, and the like.

CSPO-selected Zf proteins are typically first tested for activity in vitro using cultured cells, e.g., 293 cells, CHO cells, VERO cells, BHK cells, HeLa cells, COS cells, and the like. Preferably, human cells are used. The CSPO-selected Zf protein is often first tested using a transient expression system with a reporter gene, and then regulation of the target endogenous gene is tested in cells and in animals, both in vivo and ex vivo. The CSPO-selected Zf protein can be recombinantly expressed in a cell, recombinantly expressed in cells transplanted into an animal, or recombinantly expressed in a transgenic animal, as well as administered as a protein to an animal or cell using delivery vehicles described below. The cells can be immobilized, be in solution, be injected into an animal, or be naturally occurring in a transgenic or non-transgenic animal.

Modulation of gene expression is tested using one of the in vitro or in vivo assays described herein. Samples or assays are treated with the CSPO-selected Zf protein and compared to un-treated control samples, to examine the extent of modulation. For regulation of endogenous gene expression, the CSPO-selected Zf protein ideally has a K_{D} of 200 nM or less, more preferably 100 nM or less, more preferably 50 nM, most preferably 25 nM or less. The effects of the CSPO-selected Zf protein can be measured by examining any of the parameters described above. Any suitable gene expression, phenotypic, or physiological change can be used to assess the influence of the CSPO-selected Zf protein. When the functional consequences are determined using intact cells or animals, one can also measure a variety of effects such as tumor growth, neovascularization, hormone release, transcriptional changes to both known and uncharacterized genetic markers (e.g., northern blots or oligonucleotide array studies), changes in cell metabolism such as cell growth or pH changes, and changes in intracellular second messengers such as cGMP.

Preferred assays for regulation of endogenous gene expression can be performed in vitro. In one in vitro assay format, the CSPO-selected Zf protein regulation of endogenous gene expression in cultured cells is measured by examining protein production using an ELISA assay. The test sample is compared to control cells treated with an empty vector or an unrelated Zf protein that is targeted to another gene.

In another embodiment, regulation of endogenous gene expression is determined in vitro by measuring the level of target gene mRNA expression. The level of gene expression is measured using amplification, e.g., using RT-PCR, LCR, or hybridization assays, e.g., northern hybridization, RNase protection, dot blotting. RNase protection is used in one embodiment. The level of protein or mRNA is detected using directly or indirectly labeled detection agents, e.g., fluorescently or radioactively labeled nucleic acids, radioactively or enzymatically labeled antibodies, and the like, as described herein.

Alternatively, a reporter gene system can be devised using the target gene promoter operably linked to a reporter gene such as luciferase, green fluorescent protein, CAT, or β-galactosidase. The reporter construct is typically co-transfected into a cultured cell. After treatment with the CSPO-selected Zf protein, the amount of reporter gene transcription, translation, or activity is measured according to standard techniques known to those of skill in the art.

Another example of an assay format useful for monitoring regulation of endogenous gene expression is performed in vivo. This assay is particularly useful for examining Zf proteins that inhibit expression of tumor promoting genes, genes involved in tumor support, such as neovascularization (e.g., VEGF), or that activate tumor suppressor genes such as p53. In this assay, cultured tumor cells expressing the CSPO-selected Zf protein are injected subcutaneously into an immune compromised mouse such as an athymic mouse, an irradiated mouse, or a SCID mouse. After a suitable length of time, preferably 4-8 weeks, tumor growth is measured, e.g., by volume or by its two largest dimensions, and compared to the control. Tumors that have statistically significant reduction (using, e.g., Student's T test) are said to have inhibited growth. Alternatively, the extent of tumor neovascularization can also be measured. Immunoassays using endothelial cell specific antibodies are used to stain for vascularization of the tumor and the number of vessels in the tumor. Tumors that have a statistically significant reduction in the number of vessels (using, e.g., Student's T test) are said to have inhibited neovascularization.

Transgenic and non-transgenic animals can also be used for examining regulation of endogenous gene expression in vivo. Transgenic animals typically express the CSPO-selected Zf protein. Alternatively, animals that transiently express the CSPO-selected Zf protein, or to which the CSPO-selected Zf protein has been administered in a delivery vehicle, can be used. Regulation of endogenous gene expression is tested using any one of the assays described herein.

XII. Use of CSPO Selected Proteins in Gene Therapy.

The CSPO-selected proteins of the present invention can be used to regulate gene expression in gene therapy applications in the same as has already been described for other types of synthetic zinc finger proteins, see for example U.S. Pat. No. 6,511,808, U.S. Pat. No. 6,013,453, U.S. Pat. No. 6,007,988, U.S. Pat. No. 6,503,717, U.S. patent application 2002/0164575 A1, and U.S. patent application 2002/0160940 A1.

Conventional viral and non-viral based gene transfer methods can be used to introduce nucleic acids encoding the CSPO-selected Zf protein into mammalian cells or target tissues. Such methods can be used to administer nucleic acids encoding the CSPO-selected Zf proteins to cells in vitro. Preferably, the nucleic acids encoding the CSPO-selected Zf protein s are administered for in vivo or ex vivo gene therapy uses. Non-viral vector delivery systems include DNA plasmids, naked nucleic acid, and nucleic acid complexed with a delivery vehicle such as a liposome. Viral vector delivery systems include DNA and RNA viruses, which have either episomal or integrated genomes after delivery to the cell. For a review of gene therapy procedures, see Anderson, Science 256:808-813 (1992); Nabel & Felgner, TIBTECH 11:211-217 (1993); Mitani & Caskey, TIBTECH 11:162-166 (1993); Dillon, TIBTECH 11:167-175 (1993); Miller, Nature 357:455-460 (1992); Van Brunt, Biotechnology 6(10):1149-1154 (1988); Vigne, Restorative Neurology and Neuroscience 8:35-36 (1995); Kremer & Perricaudet, British Medical Bulletin 51(1):31-44 (1995); Haddada et al., in Current Topics in Microbiology and Immunology Doerfler and Bohm (eds) (1995); and Yu et al., Gene Therapy 1:13-26 (1994).

Methods of non-viral delivery of nucleic acids encoding the CSPO-selected Zf proteins include lipofection, microinjection, biolistics, virosomes, liposomes, immunoliposomes, polycation or lipid:nucleic acid conjugates, naked DNA, artificial virions, and agent-enhanced uptake of DNA. Lipofection is described in e.g., U.S. Pat. No. 5,049,386, No. 4,946,787; and No.4,897,355) and lipofection reagents are sold commercially (e.g., Transfectam.™. and Lipofectin.™.). Cationic and neutral lipids that are suitable for efficient receptor-recognition lipofection of polynucleotides include those of Felgner, WO 91/17424, WO 91/16024. Delivery can be to cells (ex vivo administration) or target tissues (in vivo administration).

The preparation of lipid:nucleic acid complexes, including targeted liposomes such as immunolipid complexes, is well known to one of skill in the art (see, e.g., Crystal, Science 270:404-410 (1995); Blaese et al., Cancer Gene Ther. 2:291-297 (1995); Behr et al., Bioconjugate Chem. 5:382-389 (1994); Remy et al., Bioconjugate Chem. 5:647-654 (1994); Gao et al., Gene Therapy 2:710-722 (1995); Ahmad et al., Cancer Res. 52:4817-4820 (1992); U.S. Pat. Nos. 4,186,183, 4,217,344, 4,235,871, 4,261,975, 4,485,054, 4,501,728, 4,774,085, 4,837,028, and 4,946,787).

The use of RNA or DNA viral based systems for the delivery of nucleic acids encoding the CSPO-selected Zf proteins takes advantage of highly evolved processes for targeting a virus to specific cells in the body and trafficking the viral payload to the nucleus. Viral vectors can be administered directly to patients (in vivo) or they can be used to treat cells in vitro and the modified cells are administered to patients (ex vivo). Conventional viral based systems for the delivery of Zf proteins could include retroviral, lentivirus, adenoviral, adeno-associated and herpes simplex virus vectors for gene transfer. Viral vectors are currently the most efficient and versatile method of gene transfer in target cells and tissues. Integration in the host genome is possible with the retrovirus, lentivirus, and adeno-associated virus gene transfer methods, often resulting in long term expression of the inserted transgene. Additionally, high transduction efficiencies have been observed in many different cell types and target tissues.

The tropism of a retrovirus can be altered by incorporating foreign envelope proteins, expanding the potential target population of target cells. Lentiviral vectors are retroviral vectors that are able to transduce or infect non-dividing cells and typically produce high viral titers. Selection of a retroviral gene transfer system would therefore depend on the target tissue. Retroviral vectors are comprised of cis-acting long terminal repeats with packaging capacity for up to 6-10 kb of foreign sequence. The minimum cis-acting LTRs are sufficient for replication and packaging of the vectors, which are then used to integrate the therapeutic gene into the target cell to provide permanent transgene expression. Widely used retroviral vectors include those based upon murine leukemia virus (MuLV), gibbon ape leukemia virus (GaLV), Simian Immuno deficiency virus (SIV), human immuno deficiency virus (HIV), and combinations thereof (see, e.g., Buchscher et al., J. Virol. 66:2731-2739 (1992); Johann et al., J. Virol. 66:1635-1640 (1992); Sommerfelt et al., Virol. 176:58-59 (1990); Wilson et al., J. Virol. 63:2374-2378 (1989); Miller et al., J. Virol. 65:2220-2224 (1991); PCT/US94/05700).

In applications where transient expression of the CSPO-selected Zf protein is preferred, adenoviral based systems are typically used. Adenoviral based vectors are capable of very high transduction efficiency in many cell types and do not require cell division. With such vectors, high titer and levels of expression have been obtained. This vector can be produced in large quantities in a relatively simple system. Adeno-associated virus (“AAV”) vectors are also used to transduce cells with target nucleic acids, e.g., in the in vitro production of nucleic acids and peptides, and for in vivo and ex vivo gene therapy procedures (see, e.g., West et al., Virology 160:38-47 (1987); U.S. Pat. No. 4,797,368; WO 93/24641; Kotin, Human Gene Therapy 5:793-801 (1994); Muzyczka, J. Clin. Invest. 94:1351 (1994). Construction of recombinant AAV vectors are described in a number of publications, including U.S. Pat. No. 5,173,414; Tratschin et al., Mol. Cell. Biol. 5:3251-3260 (1985); Tratschin, et al., Mol. Cell. Biol. 4:2072-2081 (1984); Hermonat & Muzyczka, PNAS 81:6466-6470 (1984); and Samulski et al., J. Virol. 63:03822-3828 (1989).

In particular, at least six viral vector approaches are currently available for gene transfer in clinical trials, with retroviral vectors by far the most frequently used system. All of these viral vectors utilize approaches that involve complementation of defective vectors by genes inserted into helper cell lines to generate the transducing agent.

pLASN and MFG-S are examples are retroviral vectors that have been used in clinical trials (Dunbar et al., Blood 85:3048-305 (1995); Kohn et al., Nat. Med. 1:1017-102 (1995); Malech et al., PNAS 94:22 12133-12138 (1997)). PA317/pLASN was the first therapeutic vector used in a gene therapy trial. (Blaese et al., Science 270:475-480 (1995)). Transduction efficiencies of 50% or greater have been observed for MFG-S packaged vectors. (Ellem et al., Immunol Immunother. 44(1): 10-20 (1997); Dranoffet al., Hum. Gene Ther. 1:111-2 (1997).

Recombinant adeno-associated virus vectors (rAAV) are a promising alternative gene delivery systems based on the defective and nonpathogenic parvovirus adeno-associated type 2 virus. All vectors are derived from a plasmid that retains only the AAV 145 bp inverted terminal repeats flanking the transgene expression cassette. Efficient gene transfer and stable transgene delivery due to integration into the genomes of the transduced cell are key features for this vector system. (Wagner et al., Lancet 351:9117 1702-3 (1998), Kearns et al., Gene Ther. 9:748-55 (1996)).

Replication-deficient recombinant adenoviral vectors (Ad) are predominantly used for colon cancer gene therapy, because they can be produced at high titer and they readily infect a number of different cell types. Most adenovirus vectors are engineered such that a transgene replaces the Ad E1a, E1b, and E3 genes; subsequently the replication defector vector is propagated in human 293 cells that supply deleted gene function in trans. Ad vectors can transduce multiple types of tissues in vivo, including nondividing, differentiated cells such as those found in the liver, kidney and muscle system tissues. Conventional Ad vectors have a large carrying capacity. An example of the use of an Ad vector in a clinical trial involved polynucleotide therapy for antitumor immunization with intramuscular injection (Sterman et al., Hum. Gene Ther. 7:1083-9 (1998)). Additional examples of the use of adenovirus vectors for gene transfer in clinical trials include Rosenecker et al., Infection 24:15-10 (1996); Sterman et al., Hum. Gene Ther. 9:7 1083-1089 (1998); Welsh et al., Hum. Gene Ther. 2:205-18 (1995); Alvarez et al., Hum. Gene Ther. 5:597-613 (1997); Topf et al., Gene Ther. 5:507-513 (1998); Sterman et al., Hum. Gene Ther. 7:1083-1089 (1998).

Packaging cells are used to form virus particles that are capable of infecting a host cell. Such cells include 293 cells, which package adenovirus, and Ψ2 cells or PA317 cells, which package retrovirus. Viral vectors used in gene therapy are usually generated by producer cell line that packages a nucleic acid vector into a viral particle. The vectors typically contain the minimal viral sequences required for packaging and subsequent integration into a host, other viral sequences being replaced by an expression cassette for the protein to be expressed. The missing viral functions are supplied in trans by the packaging cell line. For example, AAV vectors used in gene therapy typically only possess ITR sequences from the AAV genome which are required for packaging and integration into the host genome. Viral DNA is packaged in a cell line, which contains a helper plasmid encoding the other AAV genes, namely rep and cap, but lacking ITR sequences. The cell line is also infected with adenovirus as a helper. The helper virus promotes replication of the AAV vector and expression of AAV genes from the helper plasmid. The helper plasmid is not packaged in significant amounts due to a lack of ITR sequences. Contamination with adenovirus can be reduced by, e.g., heat treatment to which adenovirus is more sensitive than AAV.

In many gene therapy applications, it is desirable that the gene therapy vector be delivered with a high degree of specificity to a particular tissue type. A viral vector is typically modified to have specificity for a given cell type by expressing a ligand as a fusion protein with a viral coat protein on the viruses outer surface. The ligand is chosen to have affinity for a receptor known to be present on the cell type of interest. For example, Han et al., PNAS 92:9747-9751 (1995), reported that Moloney murine leukemia virus can be modified to express human heregulin fused to gp70, and the recombinant virus infects certain human breast cancer cells expressing human epidermal growth factor receptor. This principle can be extended to other pairs of virus expressing a ligand fusion protein and target cell expressing a receptor. For example, filamentous phage can be engineered to display antibody fragments (e.g., FAB or Fv) having specific binding affinity for virtually any chosen cellular receptor. Although the above description applies primarily to viral vectors, the same principles can be applied to nonviral vectors. Such vectors can be engineered to contain specific uptake sequences thought to favor uptake by specific target cells.

Gene therapy vectors can be delivered in vivo by administration to an individual patient, typically by systemic administration (e.g., intravenous, intraperitoneal, intramuscular, subdermal, or intracranial infusion) or topical application, as described below. Alternatively, vectors can be delivered to cells ex vivo, such as cells explanted from an individual patient (e.g., lymphocytes, bone marrow aspirates, tissue biopsy) or universal donor hematopoietic stem cells, followed by reimplantation of the cells into a patient, usually after selection for cells which have incorporated the vector.

Ex vivo cell transfection for diagnostics, research, or for gene therapy (e.g., via re-infusion of the transfected cells into the host organism) is well known to those of skill in the art. In a preferred embodiment, cells are isolated from the subject organism, transfected with nucleic acid (gene or cDNA), encoding the CSPO-selected Zf protein, and re-infused back into the subject organism (e.g., patient). Various cell types suitable for ex vivo transfection are well known to those of skill in the art (see, e.g., Freshney et al., Culture of Animal Cells, A Manual of Basic Technique (3rd ed. 1994)) and the references cited therein for a discussion of how to isolate and culture cells from patients).

In one embodiment, stem cells are used in ex vivo procedures for cell transfection and gene therapy. The advantage to using stem cells is that they can be differentiated into other cell types in vitro, or can be introduced into a mammal (such as the donor of the cells) where they will engraft in the bone marrow. Methods for differentiating CD34+ cells in vitro into clinically important immune cell types using cytokines such a GM-CSF, IFN-gamma. and TNF-alpha. are known (see Inaba et al., J. Exp. Med. 176:1693-1702 (1992)).

Stem cells are isolated for transduction and differentiation using known methods. For example, stem cells are isolated from bone marrow cells by panning the bone marrow cells with antibodies which bind unwanted cells, such as CD4+ and CD8+ (T cells), CD45+ (panB cells), GR-1 (granulocytes), and 1ad (differentiated antigen presenting cells) (see Inaba et al., J. Exp. Med. 176:1693-1702 (1992)).

Vectors (e.g., retroviruses, adenoviruses, liposomes, etc.) containing the CSPO-selected Zf protein nucleic acids can be also administered directly to the organism for transduction of cells in vivo. Alternatively, naked DNA can be administered. Administration is by any of the routes normally used for introducing a molecule into ultimate contact with blood or tissue cells. Suitable methods of administering such nucleic acids are available and well known to those of skill in the art, and, although more than one route can be used to administer a particular composition, a particular route can often provide a more immediate and more effective reaction than another route. Alternatively, stable formulations of the CSPO-selected Zf protein can also be administered.

Pharmaceutically acceptable carriers are determined in part by the particular composition being administered, as well as by the particular method used to administer the composition. Accordingly, there is a wide variety of suitable formulations of pharmaceutical compositions available, as described below (see, e.g., Remington's Pharmaceutical Sciences, 17th ed., 1989).

XIII. Delivery Vehicles.

An important factor in the administration of polypeptide compounds, such as the CSPO-selected Zf proteins of the present invention, is ensuring that the polypeptide has the ability to traverse the plasma membrane of a cell, or the membrane of an intra-cellular compartment such as the nucleus. Cellular membranes are composed of lipid-protein bilayers that are freely permeable to small, nonionic lipophilic compounds and are inherently impermeable to polar compounds, macromolecules, and therapeutic or diagnostic agents. However, proteins and other compounds such as liposomes have been described, which have the ability to translocate polypeptides such as CSPO-selected Zf protein across a cell membrane.

For example, “membrane translocation polypeptides” have amphiphilic or hydrophobic amino acid subsequences that have the ability to act as membrane-translocating carriers. In one embodiment, homeodomain proteins have the ability to translocate across cell membranes. The shortest internalizable peptide of a homeodomain protein, Antennapedia, was found to be the third helix of the protein, from amino acid position 43 to 58 (see, e.g., Prochiantz, Current Opinion in Neurobiology 6:629-634 (1996)). Another subsequence, the h (hydrophobic) domain of signal peptides, was found to have similar cell membrane translocation characteristics (see, e.g., Lin et al., J. Biol. Chem. 270:1 4255-14258 (1995)).

Examples of peptide sequences which can be linked to a protein, for facilitating uptake of the protein into cells, include, but are not limited to: an 11 animo acid peptide of the tat protein of HIV; a 20 residue peptide sequence which corresponds to amino acids 84-103 of the p16 protein (see Fahraeus et al., Current Biology 6:84 (1996)); the third helix of the 60-amino acid long homeodomain of Antennapedia (Derossi et al., J. Biol. Chem. 269:10444 (1994)); the h region of a signal peptide, such as the Kaposi fibroblast growth factor (K-FGF) h region (Lin et al., supra); or the VP22 translocation domain from HSV (Elliot & O'Hare, Cell 88:223-233 (1997)). Other suitable chemical moieties that provide enhanced cellular uptake may also be chemically linked to the CSPO-selected Zf proteins of the present invention.

Toxin molecules also have the ability to transport polypeptides across cell membranes. Often, such molecules are composed of at least two parts (called “binary toxins”): a translocation or binding domain or polypeptide and a separate toxin domain or polypeptide. Typically, the translocation domain or polypeptide binds to a cellular receptor, and then the toxin is transported into the cell. Several bacterial toxins, including Clostridium perfringens iota toxin, diphtheria toxin (DT), Pseudomonas exotoxin A (PE), pertussis toxin (PT), Bacillus anthracis toxin, and pertussis adenylate cyclase (CYA), have been used in attempts to deliver peptides to the cell cytosol as internal or amino-terminal fusions (Arora et al., J. Biol. Chem., 268:3334-3341 (1993); Perelle et al., Infect. Immun., 61:5147-5156 (1993); Stenmark et al., J. Cell Biol. 113:1025-1032 (1991); Donnelly et al., PNAS 90:3530-3534 (1993); Carbonetti et al., Abstr. Annu. Meet. Am. Soc. Microbiol. 95:295 (1995); Sebo et al., Infect. Immun. 63:3851-3857 (1995); Klimpel et al., PNAS U.S.A. 89:10277-10281 (1992); and Novak et al., J. Biol. Chem. 267:17186-17193 1992)).

Such subsequences can be used to translocate CSPO-selected Zf proteins across a cell membrane. The CSPO-selected Zf proteins can be conveniently fused to or derivatized with such sequences. Typically, the translocation sequence is provided as part of a fusion protein. Optionally, a linker can be used to link the CSPO-selected Zf protein and the translocation sequence. Any suitable linker can be used, e.g., a peptide linker.

The CSPO-selected Zf protein can also be introduced into an animal cell, preferably a mammalian cell, via liposomes and liposome derivatives such as immunoliposomes. The term “liposome” refers to vesicles comprised of one or more concentrically ordered lipid bilayers, which encapsulate an aqueous phase. The aqueous phase typically contains the compound to be delivered to the cell, i.e., the CSPO-selected Zf protein.

The liposome fuses with the plasma membrane, thereby releasing the compound into the cytosol. Alternatively, the liposome is phagocytosed or taken up by the cell in a transport vesicle. Once in the endosome or phagosome, the liposome either degrades or fuses with the membrane of the transport vesicle and releases its contents.

In current methods of drug delivery via liposomes, the liposome ultimately becomes permeable and releases the encapsulated compound (in this case, the CSPO-selected Zf protein) at the target tissue or cell. For systemic or tissue specific delivery, this can be accomplished, for example, in a passive manner wherein the liposome bilayer degrades over time through the action of various agents in the body. Alternatively, active compound release involves using an agent to induce a permeability change in the liposome vesicle. Liposome membranes can be constructed so that they become destabilized when the environment becomes acidic near the liposome membrane (see, e.g., PNAS 84:7851 (1987); Biochemistry 28:908 (1989)). When liposomes are endocytosed by a target cell, for example, they become destabilized and release their contents. This destabilization is termed fusogenesis. Dioleoylphosphatidylethanolamine (DOPE) is the basis of many “fusogenic” systems.

Such liposomes typically comprise the CSPO-selected Zf protein and a lipid component, e.g., a neutral and/or cationic lipid, optionally including a receptor-recognition molecule such as an antibody that binds to a predetermined cell surface receptor or ligand (e.g., an antigen). A variety of methods are available for preparing liposomes as described in, e.g., Szoka et al., Ann. Rev. Biophys. Bioeng. 9:467 (1980), U.S. Pat. Nos. 4,186,183, 4,217,344, 4,235,871, 4,261,975, 4,485,054, 4,501,728, 4,774,085, 4,837,028, 4,235,871, 4,261,975, 4,485,054, 4,501,728, 4,774,085, 4,837,028, 4,946,787, PCT Publication. No. WO 91.backslash.17424, Deamer & Bangham, Biochim. Biophys. Acta 443:629-634 (1976); Fraley, et al., PNAS 76:3348-3352 (1979); Hope et al., Biochim. Biophys. Acta 812:55-65 (1985); Mayer et al., Biochim. Biophys. Acta 858:161-168 (1986); Williams et al., PNAS 85:242-246 (1988); Liposomes (Ostro (ed.), 1983, Chapter 1); Hope et al., Chem. Phys. Lip. 40:89 (1986); Gregoriadis, Liposome Technology (1984) and Lasic, Liposomes: from Physics to Applications (1993)). Suitable methods include, for example, sonication, extrusion, high pressure/homogenization, microfluidization, detergent dialysis, calcium-induced fusion of small liposome vesicles and ether-fusion methods, all of which are well known in the art.

In certain embodiments, it is desirable to target liposomes using targeting moieties that are specific to a particular cell type, tissue, and the like. Targeting of liposomes using a variety of targeting moieties (e.g., ligands, receptors, and monoclonal antibodies) has been previously described (see, e.g., U.S. Pat. Nos. 4,957,773 and 4,603,044).

Examples of targeting moieties include monoclonal antibodies specific to antigens associated with neoplasms, such as prostate cancer specific antigen and MAGE. Tumors can also be diagnosed by detecting gene products resulting from the activation or over-expression of oncogenes, such as ras or c-erbB2. In addition, many tumors express antigens normally expressed by fetal tissue, such as the alphafetoprotein (AFP) and carcinoembryonic antigen (CEA). Sites of viral infection can be diagnosed using various viral antigens such as hepatitis B core and surface antigens (HBVc, HBVs) hepatitis C antigens, Epstein-Barr virus antigens, human immunodeficiency type-1 virus (HIV1) and papilloma virus antigens. Inflammation can be detected using molecules specifically recognized by surface molecules which are expressed at sites of inflammation such as integrins (e.g., VCAM-1), selectin receptors (e.g., ELAM-1) and the like.

Standard methods for coupling targeting agents to liposomes can be used. These methods generally involve incorporation into liposomes lipid components, e.g., phosphatidylethanolamine, which can be activated for attachment of targeting agents, or derivatized lipophilic compounds, such as lipid derivatized bleomycin. Antibody targeted liposomes can be constructed using, for instance, liposomes which incorporate protein A (see Renneisen et al., J. Biol. Chem., 265:16337-16342 (1990) and Leonetti et al., PNAS 87:2448-2451 (1990).

XIV. Dosages.

For therapeutic applications, the dose of the CSPO-selected Zf protein to be administered to a patient is calculated in the same was as has already been described for other types of synthetic zinc finger proteins, see for example U.S. Pat. No. 6,511,808, U.S. Pat. No. 6,492,117, U.S. Pat. No. 6,453,242, U.S. patent application 2002/0164575 A1, and U.S. patent application 2002/0160940 A1. In the context of the present disclosure, the dose should be sufficient to effect a beneficial therapeutic response in the patient over time. In addition, particular dosage regimens can be useful for determining phenotypic changes in an experimental setting, e.g., in functional genomics studies, and in cell or animal models. The dose will be determined by the efficacy, specificity, and K_{D} of the particular CSPO-selected Zf protein employed, the nuclear volume of the target cell, and the condition of the patient, as well as the body weight or surface area of the patient to be treated. The size of the dose also will be determined by the existence, nature, and extent of any adverse side-effects that accompany the administration of a particular compound or vector in a particular patient.

XV. Pharmaceutical Compositions and Administration.

Appropriate pharmaceutical compositions for administration of the CSPO-selected Zf proteins of the present invention are determined as already described for other types of synthetic zinc finger proteins, see for example U.S. Pat. No. 6,511,808, U.S. Pat. No. 6,492,117, U.S. Pat. No. 6,453,242, U.S. patent application 2002/0164575 A1, and U.S. patent application 2002/0160940 A1CSPO-selected Zf proteins, and expression vectors encoding CSPO-selected Zf proteins, can be administered directly to the patient for modulation of gene expression and for therapeutic or prophylactic applications, for example, cancer, ischemia, diabetic retinopathy, macular degeneration, rheumatoid arthritis, psoriasis, HIV infection, sickle cell anemia, Alzheimer's disease, muscular dystrophy, neurodegenerative diseases, vascular disease, cystic fibrosis, stroke, and the like. Examples of microorganisms that can be inhibited by Zf gene therapy include pathogenic bacteria, e.g., chlamydia, rickettsial bacteria, mycobacteria, staphylococci, streptococci, pneumococci, meningococci and conococci, klebsiella, proteus, serratia, pseudomonas, legionella, diphtheria, salmonella, bacilli, cholera, tetanus, botulism, anthrax, plague, leptospirosis, and Lyme disease bacteria; infectious fungus, e.g., Aspergillus, Candida species; protozoa such as sporozoa (e.g., Plasmodia), rhizopods (e.g., Entamoeba) and flagellates (Trypanosoma, Leishmania, Trichomonas, Giardia, etc.); viral diseases, e.g., hepatitis (A, B, or C), herpes virus (e.g., VZV, HSV-1, HSV-6, HSV-II, CMV, and EBV), HIV, Ebola, adenovirus, influenza virus, flaviviruses, echovirus, rhinovirus, coxsackie virus, comovirus, respiratory syncytial virus, mumps virus, rotavirus, measles virus, rubella virus, parvovirus, vaccinia virus, HTLV virus, dengue virus, papillomavirus, poliovirus, rabies virus, and arboviral encephalitis virus, etc.

Administration of therapeutically effective amounts is by any of the routes normally used for introducing Zf proteins into ultimate contact with the tissue to be treated. The Zf proteins are administered in any suitable manner, preferably with pharmaceutically acceptable carriers. Suitable methods of administering such modulators are available and well known to those of skill in the art, and, although more than one route can be used to administer a particular composition, a particular route can often provide a more immediate and more effective reaction than another route.

Pharmaceutically acceptable carriers are determined in part by the particular composition being administered, as well as by the particular method used to administer the composition. Accordingly, there is a wide variety of suitable formulations of pharmaceutical compositions that are available (see, e.g., Remington's Pharmaceutical Sciences, 17.sup.th ed. 1985)).

The CSPO-selected Zf proteins, alone or in combination with other suitable components, can be made into aerosol formulations (i.e., they can be “nebulized”) to be administered via inhalation. Aerosol formulations can be placed into pressurized acceptable propellants, such as dichlorodifluoromethane, propane, nitrogen, and the like.

Formulations suitable for parenteral administration, such as, for example, by intravenous, intramuscular, intradermal, and subcutaneous routes, include aqueous and non-aqueous, isotonic sterile injection solutions, which can contain antioxidants, buffers, bacteriostats, and solutes that render the formulation isotonic with the blood of the intended recipient, and aqueous and non-aqueous sterile suspensions that can include suspending agents, solubilizers, thickening agents, stabilizers, and preservatives. The disclosed compositions can be administered, for example, by intravenous infusion, orally, topically, intraperitoneally, intravesically or intrathecally. The formulations of compounds can be presented in unit-dose or multi-dose sealed containers, such as ampules and vials. Injection solutions and suspensions can be prepared from sterile powders, granules, and tablets of the kind previously described.

XVI. Regulation of Gene Expression in Plants

CSPO-selected Zf proteins can be used to engineer plants for traits such as increased disease resistance, modification of structural and storage polysaccharides, flavors, proteins, and fatty acids, fruit ripening, yield, color, nutritional characteristics, improved storage capability, and the like. In particular, the engineering of crop species for enhanced oil production, e.g., the modification of the fatty acids produced in oilseeds, is of interest.

Seed oils are composed primarily of triacylglycerols (TAGs), which are glycerol esters of fatty acids. Commercial production of these vegetable oils is accounted for primarily by six major oil crops (soybean, oil palm, rapeseed, sunflower, cotton seed, and peanut). Vegetable oils are used predominantly (90%) for human consumption as margarine, shortening, salad oils, and frying oil. The remaining 10% is used for non-food applications such as lubricants, oleochemicals, biofuels, detergents, and other industrial applications.

The desired characteristics of the oil used in each of these applications varies widely, particularly in terms of the chain length and number of double bonds present in the fatty acids making up the TAGs. These properties are manipulated by the plant in order to control membrane fluidity and temperature sensitivity. The same properties can be controlled using CSPO-selected Zf protein to produce oils with improved characteristics for food and industrial uses.

The primary fatty acids in the TAGs of oilseed crops are 16 to 18 carbons in length and contain 0 to 3 double bonds. Palmitic acid (16:0 [16 carbons: 0 double bonds]), oleic acid (18:1), linoleic acid (18:2), and linolenic acid (18:3) predominate. The number of double bonds, or degree of saturation, determines the melting temperature, reactivity, cooking performance, and health attributes of the resulting oil.

The enzyme responsible for the conversion of oleic acid (18:1) into linoleic acid (18:2) (which is then the precursor for 18:3 formation) is .DELTA.12-oleate desaturase, also referred to as omega-6 desaturase. A block at this step in the fatty acid desaturation pathway should result in the accumulation of oleic acid at the expense of polyunsaturates.

In one embodiment CSPO-selected Zf proteins are used to regulate expression of the FAD2-1 gene in soybeans. Two genes encoding microsomal delta-6 desaturases have been cloned recently from soybean, and are referred to as FAD2-1 and FAD2-2 (Heppard et al., Plant Physiol. 110:311-319 (1996)). FAD2-1 (δ-12 desaturase) appears to control the bulk of oleic acid desaturation in the soybean seed. CSPO-selected Zf proteins can thus be used to modulate gene expression of FAD2-1 in plants. Specifically, CSPO-selected Zf proteins can be used to inhibit expression of the FAD2-1 gene in soybean in order to increase the accumulation of oleic acid (18:1) in the oil seed. Moreover, CSPO-selected Zf proteins can be used to modulate expression of any other plant gene, such as delta-9 desaturase, delta-12 desaturases from other plants, delta-15 desaturase, acetyl-CoA carboxylase, acyl-ACP-thioesterase, ADP-glucose pyrophosphorylase, starch synthase, cellulose synthase, sucrose synthase, senescence-associated genes, heavy metal chelators, fatty acid hydroperoxide lyase, polygalacturonase, EPSP synthase, plant viral genes, plant fungal pathogen genes, and plant bacterial pathogen genes.

Recombinant DNA vectors suitable for transformation of plant cells are also used to deliver protein (e.g., CSPO-selected Zf proteins)-encoding nucleic acids to plant cells. Techniques for transforming a wide variety of higher plant species are well known and described in the technical and scientific literature (see, e.g., Weising et al. Ann. Rev. Genet. 22:421-477 (1988)). A DNA sequence coding for the desired Zf protein is combined with transcriptional and translational initiation regulatory sequences which will direct the transcription of the Zf protein in the intended tissues of the transformed plant.

For example, a plant promoter fragment may be employed which will direct expression of the CSPO-selected Zf protein in all tissues of a regenerated plant. Such promoters are referred to herein as “constitutive” promoters and are active under most environmental conditions and states of development or cell differentiation. Examples of constitutive promoters include the cauliflower mosaic virus (CaMV) 35 S transcription initiation region, the 1′- or 2′-promoter derived from T-DNA of Agrobacterium tumafaciens, and other transcription initiation regions from various plant genes known to those of skill.

Alternatively, the plant promoter may direct expression of the CSPO-selected Zf protein in a specific tissue or may be otherwise under more precise environmental or developmental control. Such promoters are referred to here as “inducible” promoters. Examples of environmental conditions that may effect transcription by inducible promoters include anaerobic conditions or the presence of light.

Examples of promoters under developmental control include promoters that initiate transcription only in certain tissues, such as fruit, seeds, or flowers. For example, the use of a polygalacturonase promoter can direct expression of the Zf protein in the fruit, a CHS-A (chalcone synthase A from petunia) promoter can direct expression of the ZFP in flower of a plant.

The vector comprising the Zf protein sequences will typically comprise a marker gene which confers a selectable phenotype on plant cells. For example, the marker may encode biocide resistance, particularly antibiotic resistance, such as resistance to kanamycin, G418, bleomycin, hygromycin, or herbicide resistance, such as resistance to chlorosluforon or Basta.

Such DNA constructs may be introduced into the genome of the desired plant host by a variety of conventional techniques. For example, the DNA construct may be introduced directly into the genomic DNA of the plant cell using techniques such as electroporation and microinjection of plant cell protoplasts, or the DNA constructs can be introduced directly to plant tissue using biolistic methods, such as DNA particle bombardment. Alternatively, the DNA constructs may be combined with suitable T-DNA flanking regions and introduced into a conventional Agrobacterium tumefaciens host vector. The virulence functions of the Agrobacterium tumefaciens host will direct the insertion of the construct and adjacent marker into the plant cell DNA when the cell is infected by the bacteria.

Microinjection techniques are known in the art and well described in the scientific and patent literature. The introduction of DNA constructs using polyethylene glycol precipitation is described in Paszkowski et al. EMBO J. 3:2717-2722 (1984). Electroporation techniques are described in Fromm et al. PNAS 82:5824 (1985). Biolistic transformation techniques are described in Klein et al. Nature 327:70-73 (1987).

Agrobacterium tumefaciens-meditated transformation techniques are well described in the scientific literature (see, e.g., Horsch et al Science 233:496-498 (1984)); and Fraley et al. PNAS 80:4803 (1983)).

Transformed plant cells which are derived by any of the above transformation techniques can be cultured to regenerate a whole plant which possesses the transformed genotype and thus the desired Zf protein-controlled phenotype. Such regeneration techniques rely on manipulation of certain phytohormones in a tissue culture growth medium, typically relying on a biocide and/or herbicide marker which has been introduced together with the Zf protein nucleotide sequences. Plant regeneration from cultured protoplasts is described in Evans et al., Protoplasts Isolation and Culture, Handbook of Plant Cell Culture, pp. 124-176 (1983); and Binding, Regeneration of Plants, Plant Protoplasts, pp. 21-73 (1985). Regeneration can also be obtained from plant callus, explants, organs, or parts thereof. Such regeneration techniques are described generally in Klee et al. Ann. Rev. of Plant Phys. 38:467-486 (1987).

XVII. Functional Genomics Assays

CSPO-selected Zf proteins also have use for assays to determine the phenotypic consequences and function of gene expression. Recent advances in analytical techniques, coupled with focused mass sequencing efforts have created the opportunity to identify and characterize many more molecular targets than were previously available. This new information about genes and their functions will improve basic biological understanding and present many new targets for therapeutic intervention. In some cases analytical tools have not kept pace with the generation of new data. An example is provided by recent advances in the measurement of global differential gene expression. These methods, typified by gene expression microarrays, differential cDNA cloning frequencies, subtractive hybridization and differential display methods, can very rapidly identify genes that are up or down-regulated in different tissues or in response to specific stimuli. Increasingly, such methods are being used to explore biological processes such as, transformation, tumor progression, the inflammatory response, neurological disorders etc. Many differentially expressed genes correlate with a given physiological phenomenon, but demonstrating a causative relationship between an individual differentially expressed gene and the phenomenon is labor intensive. Until now, simple methods for assigning function to differentially expressed genes have not kept pace with the ability to monitor differential gene expression.

The CSPO-selected Zf technology of the present invention can be used to rapidly analyze the function of a differentially expressed gene. CSPO-selected Zf proteins can be readily used to up or down-regulate any endogenous target gene. Very little sequence information is required to create a gene-specific DNA binding domain. This makes the CSPO-selected Zf technology ideal for analysis of long lists of poorly characterized differentially expressed genes. One can simply build a zinc finger-based DNA binding domain for each candidate gene, create chimeric up and down-regulating artificial transcription factors and test the consequence of up or down-regulation on the phenotype under study (transformation, response to a cytokine etc.) by switching the candidate genes on or off one at a time in a model system.

Additionally, greater experimental control can be imparted by CSPO-selected Zf proteins than can be achieved by more conventional methods. This is because the production and/or function of CSPO-selected Zf proteins, like other Zf proteins, can be placed under small molecule control. Examples of this approach are provided by the Tet-On system, the ecdysone-regulated system and a system incorporating a chimeric factor including a mutant progesterone receptor. These systems are all capable of indirectly imparting small molecule control on any endogenous gene of interest or any transgene by placing the function and/or expression of a CSPO-selected Zf protein under small molecule control.

XVIII. Transgenic Mice

A further application of CSPO-selected Zf proteins is manipulating gene expression in animal models. As with cell lines, the introduction of a heterologous gene to a transgenic animal, such as a transgenic mouse, is a fairly straightforward process. Thus, transgenic expression of a CSPO-selected Zf protein in an animal can be readily performed.

By transgenically expressing a suitable CSPO-selected Zf protein fused to an activation domain, a target gene of interest can be over-expressed. Similarly, by transgenically expressing a suitable CSPO-selected Zf protein fused to a repressor or silencer domain, the expression of a target gene of interest can be down-regulated, or even switched off to create “functional knockout”.

Two common issues often prevent the successful application of the standard transgenic and knockout technology; embryonic lethality and developmental compensation. Embryonic lethality results when the gene plays an essential role in development. Developmental compensation is the substitution of a related gene product for the gene product being knocked out, and often results in a lack of a phenotype in a knockout mouse when the ablation of that gene's function would otherwise cause a physiological change.

Expression of transgenic CSPO-selected Zf proteins can be temporally controlled, for example using small molecule regulated systems as described in the previous section. Thus, by switching on expression of a CSPO-selected Zf protein at a desired stage in development, a gene can be over-expressed or “functionally knocked-out” in the adult (or at a late stage in development), thus avoiding the problems of embryonic lethality and developmental compensation.

### EXAMPLES

The following examples are provided to describe and illustrate, but not limit, the claimed invention. Those of skill in the art will readily recognize a variety of non-critical parameters that could be changed or modified to yield essentially similar results. As described herein, proteins produced by methods of the present invention have greater affinity and specificity for their target sites than proteins produced by alternative strategies that do not account for both finger position sensitivity and combinatorial diversity.

### Example 1

### Construction of Multi-Finger Position-Sensitive Primary Libraries

Three different randomized “Primary Libraries” were constructed, each library comprising three fingers, one of which was variable/randomized and two of which were “anchored.” In “Primary Library 1” the N-terminal Zf (Zf 1) was randomized while Zf 2 and Zf 3 were held constant. In “Primary Library 2” the middle Zf (Zf 2) was randomized while Zf 1 and Zf 3 were “anchored.” In “Primary Library 3” the C-terminal Zf (Zf 3) was randomized while Zf 1 and Zf 2 were “anchored.”. These three libraries were constructed essentially as previously described by Joung et al. (Joung et al., (2000) Proceedings of the National Academy of Sciences (USA) 97: 7382), with two exceptions. The first exception was that different finger positions were randomized for each library made (i.e. Primary Library 1, Primary Library 2, and Primary Library 3). The second exception was that the 24 codons used to randomize amino acid residues in the recognition helix, encoded only 16 of the possible 20 amino acids. The excluded amino acids were phenylalanine, tyrosine, tryptophan and cysteine. The master libraries described here were each based on an engineered zinc finger protein originally described by Choo et al. (1994, Nature 372:642). This is a three zinc finger protein in which each finger is derived from the middle finger of zif268, and which binds with low affinity to the BCR-ABL gene (referred to as BCR-ABL ZFP). Randomizaton was performed by cassette mutagenesis (Wolfe et al. 2000, Volume 7, p 739-750). Residues −1, 1, 2, 3, 5, and 6 of the recognition helix of each finger were randomized using degenerate codons of the form VNS (where V=G,A, or C, N=G, A, T, or C, and S=G or C). This codon scheme permits 16 possible amino acids (excluding the aromatics and cysteine). The libraries constructed were composed of >5×10⁸ independently derived members.

The libraries were each electroporated into E. coli XL-1 Blue cells (Stratagene) to yield transformants. The transformants were pooled, amplified and infected with VCS-M13 helper phage (Stratagene) to yield a high titer stock of phage harboring single-stranded versions of the phagemid library.

High titer stocks of Primary Libraries 1, 2, and 3 in VCS-M13 helper phage (Stratagene) (named CSPO F1, CSPO F2, and CSPO F3, respectively), were deposited with the ATCC on Oct. 23, 2003 (ATCC accession numbers to be assigned). These three libraries were used in subsequent examples by infecting the bacterial selection strains with around 10⁹ transducing units of phage from the phagemid library. Primary libraries CSPO F1, CSPO F2, and CSPO F3, can be used for the selection of any three-finger Zf protein by CSPO.

### Example 2

### Construction of Position-Sensitive Target Site

### Constructs for Selection of Zf Polypeptides that Bind to the BCR-ABL Gene

Target site constructs were synthesized as oligonucleotides and introduced just upstream of the weak test promoter in the bacterial two-hybrid system, as described in Joung et al., (2000) Proceedings of the National Academy of Sciences (USA) 97:7382.

### Example 3

### Construction of a Partially Optimized Secondary Library

The CSPO protocol (illustrated in FIG. 1) was designed so that “pools” of Zfs that bind with low affinity to their respective subsites in the primary selection could be isolated and recombined to generate a “Secondary Library.” Such secondary libraries were produced using PCR-mediated recombination of nucleotides encoding the Zf proteins identified in the primary selection, according to the method illustrated in FIG. 2. Recombined or “shuffled” zinc finger libraries containing random combinations of fingers identified in the initial low stringency selection were generated using PCR-mediated fusion of DNA fragments encoding individual finger units that preserved the position of fingers identified in the initial selections. For each library, approximately 200 selected (but unsequenced) recognition helices from each finger position were first amplified using finger position-specific primers and then randomly fused together and amplified to create a pool of DNA molecules encoding shuffled three-finger proteins. These molecules were then cloned into an appropriate plasmid for expression as a Gal11P-fusion protein. Each library created using this method contained >10⁸ independently derived members.

### Example 4

### Quantification of Target Binding Affinity and Specificity

Zf proteins selected using CSPO were characterized to determine the affinity and specificity with which they bound to their sequence of interest. DNAs encoding selected Zfs were isolated. In order to produce the encoded Zf protein in vitro, a commercially available in vitro transcription/translation system (Expressway™, Invitrogen) was used. The binding of the in vitro transcribed/translated Zf proteins to their target sites was measured assayed using electrophoretic mobility shift assays (EMSAs).

Pairs of DNA oligonucleotides 25 base pairs in length were designed to contain 5′ TTTT overhangs and a 10 bp BCR-ABL, erbB2, HIV, or Zif268 target binding site. Compatible oligonucleotides were annealed and radiolabeled with [α-³²P]dATP. The table below illustrates the primary strands of these oligonucleotide pairs:

Binding site primary strand (5′-3′)

| | |
|---|---|
| BCR-ABL | TTTTCGACACGCAGAAGCCCATTAC |
| erbB2 | TTTTCGACAAGCCGCAGTGGATTAC |
| HIV promoter | TTTTCGACACGATGCTGCATATTAC |
| Zif268 | TTTTGACGGTGCGTGGGCGGTTCAC |

EMSA assays were performed as previously described by Greisman and Pabo, Science (1997). except that a) binding buffer contained non-acetylated bovine serum albumin (100 ug/ml), b) 0.5 pM (for Zif268 and HIV) or 1 pM (for all other proteins) of the labeled DNA site was used for each binding reaction, and c) protein-DNA mixtures were incubated for 1 or 4 hours at room temperature. Results for both incubation times were comparable indicating that the binding reactions had reached equilibrium after one hour and thus the results of all of these experiments were averaged. Reactions were subjected to gel electrophoresis on Criterion 4-20% native TBE polyacrylamide gels (Bio-Rad, Hercules, Calif.). Gels were dried, exposed overnight to phosphorimaging screens, and quantitated using Quantity One imaging software (Bio-Rad). In order to determine dissociation constants, the % of DNA bound (θ) was plotted against the concentration of protein [P] in each binding reaction. SigmaPlot8 (Sigma) non-linear regression software was used to fit the curve plotted above according to Equation (1) in the manuscript by Elrod-Erickson and Pabo (J Biol Chem (1999) July 2; 274(27):19281-5) and to calculate values for the Kd of each protein. The concentration of active protein was determined for each experiment by titrating dilutions of the fusion ZFP against a fixed excess amount of unlabeled target site (12.5 nM) and a small amount of labeled target site (1 pM). Reactions were incubated and subjected to gel electrophoresis concurrently with those used for dissociation constant determination. Active protein concentrations ([P]_{stock}) were determined by plotting θ vs. 1/diln. factor according to Equation (1).

$$θ = \frac{{[ P ]}_{stock}}{di ln \cdot factor} * \frac{1}{{[ DNA ]}_{t}} \qquad ( 1 )$$

Binding site competition experiments were performed as done by Greisman et al.(Science, 1997) with the exception that 0.5 or 1 pM of radiolabeled target site was used. Specific and non-specific dissociation constants were averaged over at least three independent experiments (R²≧0.90). EMSAs were performed with a constant concentration of the DNA target sites and a range of concentrations of the Zf protein being tested. Thus, by quantifying the amount of the Zf protein bound to the target at each Zf protein concentration, it was possible to obtain a measure of the K_{D} for binding of the Zf protein to its target.

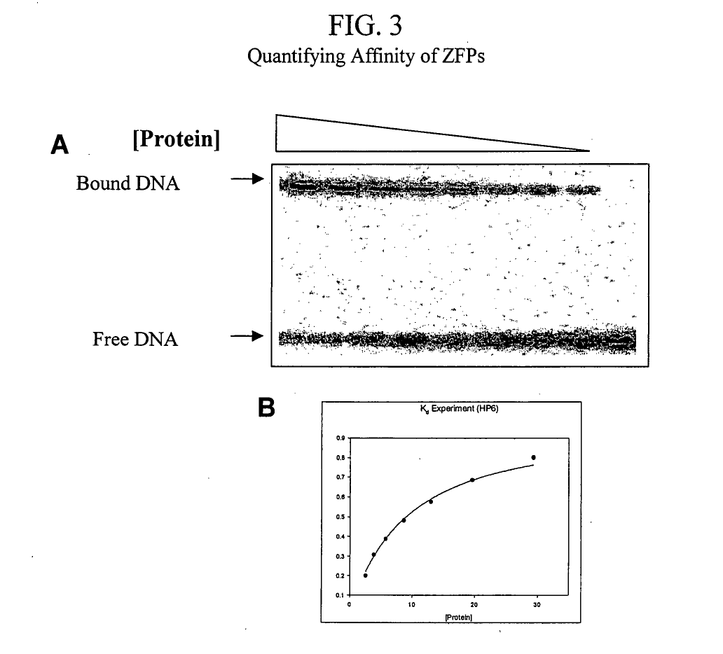

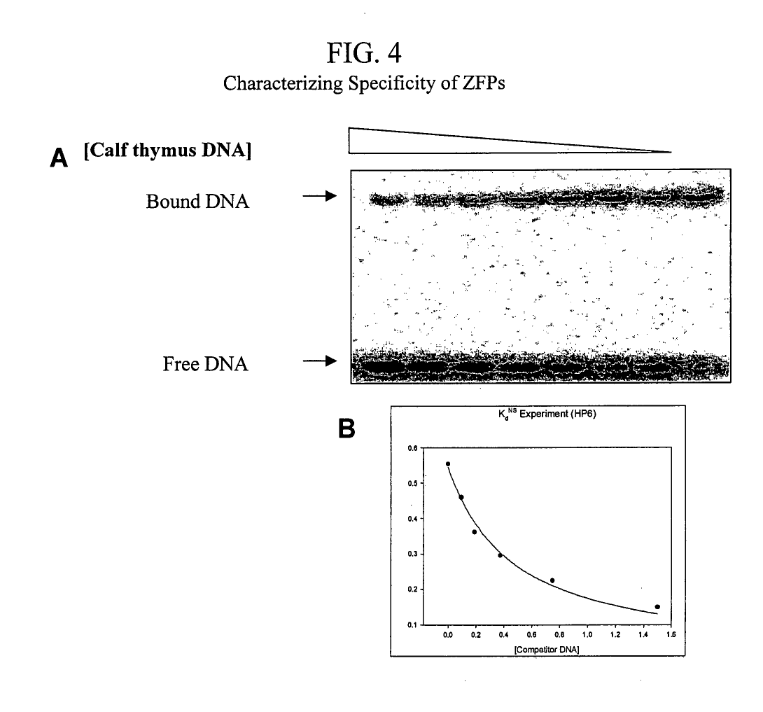

FIG. 3 shows the data EMSA (FIG. 3A) and K_{D} (FIG. 3B)data obtained for a Zf selected for binding to an HIV-1 promoter sequence using the CSPO strategy. FIG. 4 shows the results obtained when a similar EMSA was performed in which the Zf protein concentration was held constant and the concentration of non-specific competitor DNA (calf thymus DNA) was varied. By quantifying the amount of the Zf protein bound to the target at each non-specific DNA concentration, it was possible to obtain a measure of the K_{D} for binding of the Zf protein to non-specific DNA. FIG. 4A shows the EMSA data, and FIG. 4B shows the non-specific K_{D} data obtained for a Zf selected for binding to an HIV-1 promoter sequence using the CSPO strategy.

### Example 5

### Selection of Zf Polypeptides with High Affinity and Specificty for the BCR-ABL Gene

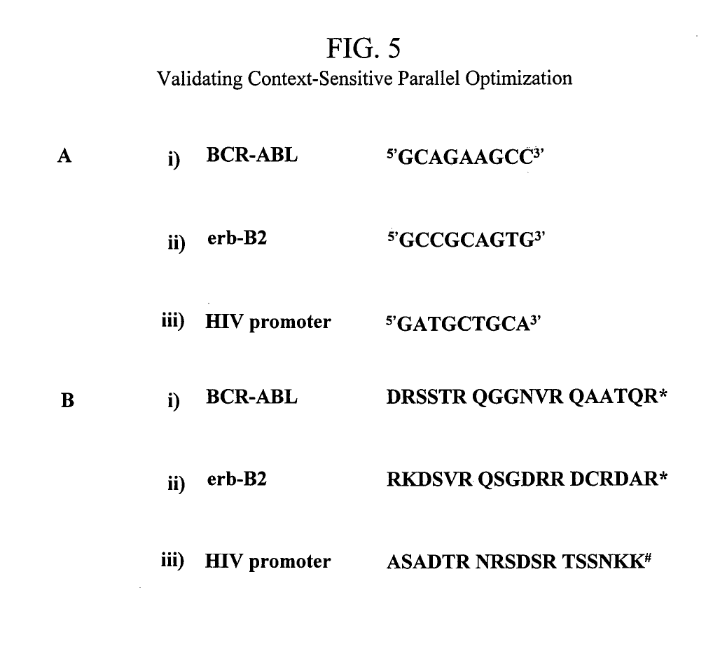

Choo et al. (1994, Nature 372:642) have previously described the use of the parallel selection strategy to select a recombinant three-finger Zf protein that binds specifically to a unique 9 bp region of a BCR-ABL fusion oncogene. This recombinant 3-finger protein (shown in FIG. 5A) has the amino acid sequence DRSSTR QGGNVR QAATQR (SEQ ID NO:8) in the recognition helices of finger 1, 2, and 3, respectively, and binds to the BCR-ABL target sequence GCA GAA GCC (SEQ ID NO:9) (shown in FIG. 5B).

In the present example, CSPO was used in conjunction with a bacterial two-hybrid selection system, to select recombinant Zfs that bind to the same 9 bp BCR-ABL target sequence, i.e. GCA GAA GCC (SEQ ID NO:9).

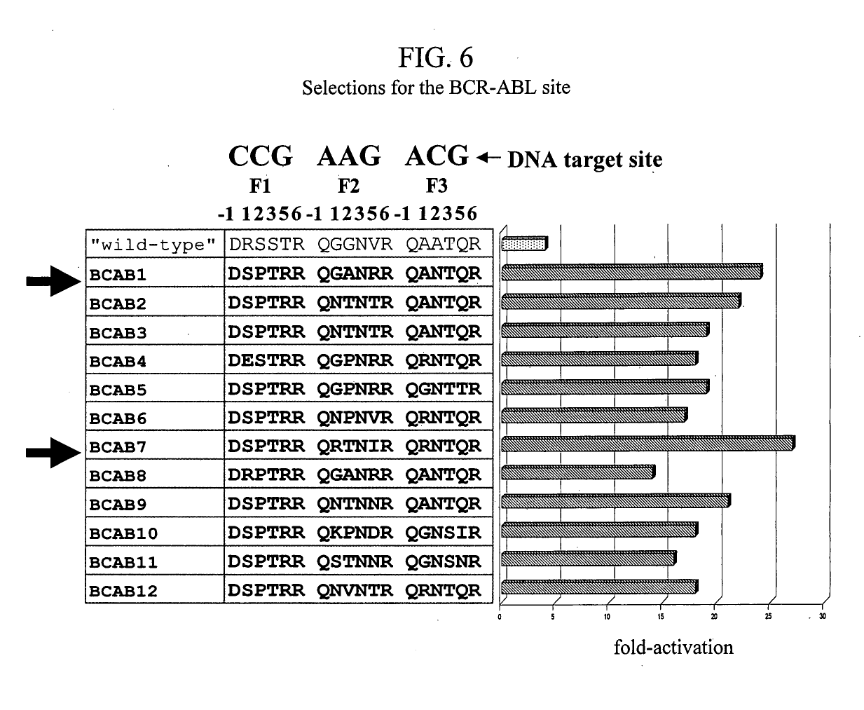

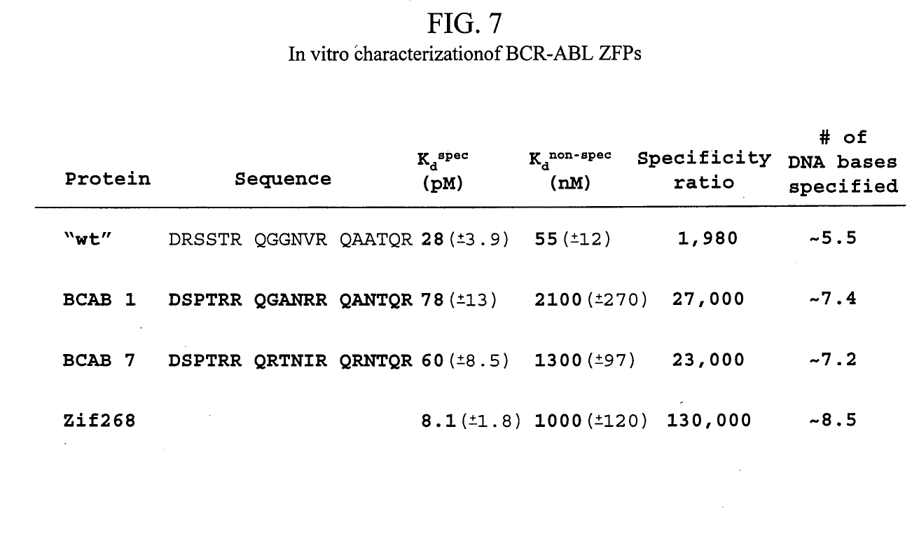

Twelve recombinant Zf proteins, termed BCAB1 through BCAB12, were selected (FIG. 6). Each of these Zf proteins differed in sequence from the Zf protein isolated by Choo et al. (referred to as “wild-type” for the purposes of this example only). The two candidates, BCAB1 and BCAB7 (indicated by arrows in FIG. 7), were further characterized and compared to the wild-type protein. Dissociation constants (K_{D}) for binding to the BCR-ABL target sequence were measured and quantified using electrophoretic mobility shift assays (EMSAs). Specificity of binding was determined by comparing the K_{D} for binding to the BCR-ABL target sequence to the K_{D} for binding to non-specific competitor DNA. FIG. 7 shows the K_{D} s for specific and non-specific binding and the calculated “specificity ratios.” The results of this analysis demonstrate that both BCAB1 and BCAB7 bind with high affinity to the BCR-ABL target sequence, and furthermore, that they bind with higher specificity than the “wild-type” protein.

Thus, using the context-sensitive parallel optimization strategy of the present invention, recombinant Zfs with desirable target binding characteristics for this BCR-ABL target sequence, have been identified.

### Example 6

### Selection with the erb-B2 Target Site

Beerli et al. (1998, Proceedings of the National Academy of Sciences (USA) 95:14628) have previously described use of a parallel selection strategy to select a recombinant three-finger Zf protein that binds specifically to a 9 bp site in the human erb-B2 gene. This recombinant 3-finger protein has the amino acid sequence RKDSVR QSGDRR DCRDAR (SEQ ID NO:10, shown in FIG. 5A) and binds to the erb-B2 sequence GCC GCA GTG (SEQ ID NO:11, shown in FIG. 5B). In the present example, CSPO was used in conjunction with a bacterial two-hybrid selectione system to select recombinant Zfs that bind to the same 9 bp erb-B2 target site, i.e. GCC GCA GTG (SEQ ID NO:11).

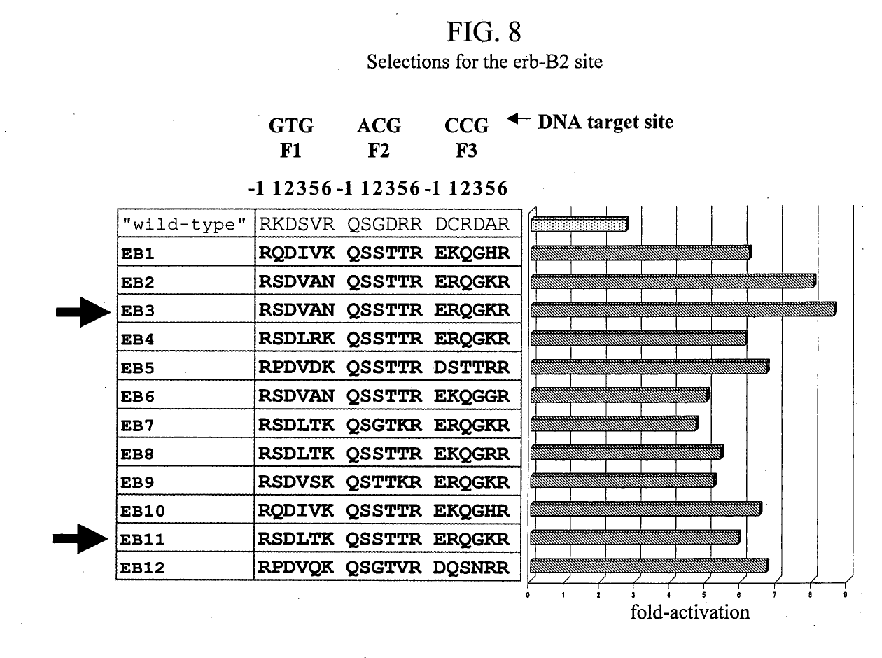

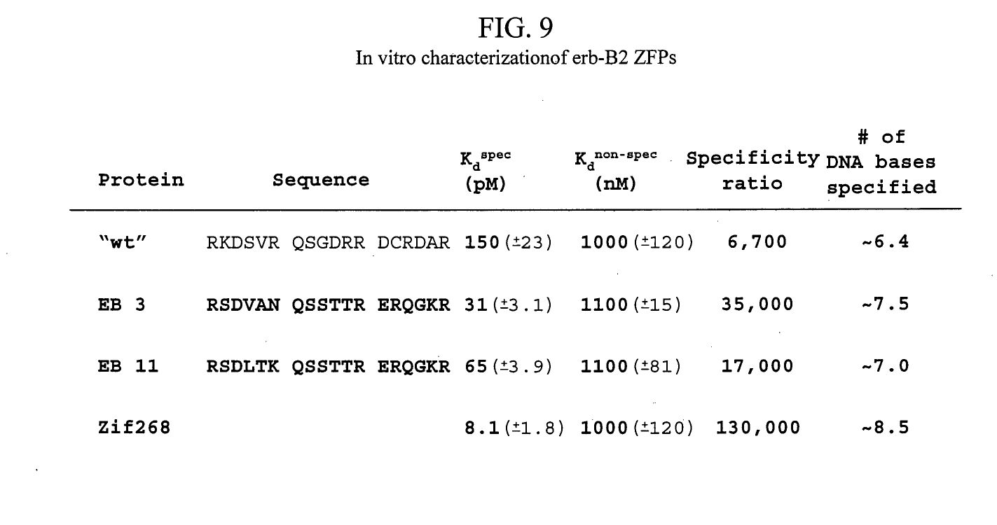

Twelve recombinant Zf proteins, termed EB1 through EB12, were selected (FIG. 8). Each of these Zf proteins differed in sequence from the Zf protein isolated by Beerli et al. (referred to as “wild-type” for the purposes of this example only). The two candidates, EB3 and EB11 (marked by arrows in FIG. 8), were further characterized and compared to the “wild-type” protein. Dissociation constants (K_{D}) for binding to the erb-B2 target sequence were measured and quantified using EMSAs. Specificity of binding was determined by comparing the K_{D} for binding to the erb-B2 target sequence to the K_{D} for binding to non-specific competitor DNA. FIG. 9 shows the K_{D} s for specific and non-specific binding and the calculated “specificity ratios.” The results of this analysis demonstrate that both EB3 and EB11 bind to the erb-B2 target with higher affinity and specificity than the “wild-type” protein.

Thus, using the context-sensitive parallel optimization strategy of the present invention, recombinant Zfs with desirable target binding characteristics for this erb-B2 target sequence, have been identified.

### Example 7

### Selection with the HIV Promoter

Isalan et al. (2001, Nature Biotechnology19: 656) have previously described the use of the bipartite selection strategy to select a recombinant three-finger Zf protein that binds specifically to a 9 bp site in the human immunodeficiency virus 1 (HIV-1) promoter. This recombinant 3-finger protein has the amino acid sequence ASADTR NRSDSR TSSNKK (SEQ ID NO:12, shown in FIG. 5A) and binds to the HIV-1 promoter target sequence GAT GCT GCA (SEQ ID NO:13, shown in FIG. 5B). In the present example, CSPO was used in conjunction with a bacterial two-hybrid selection system, to select recombinant Zfs that bind to the same 9 bp. HIV-1 promoter target sequence GAT GCT GCA (SEQ ID NO:13).

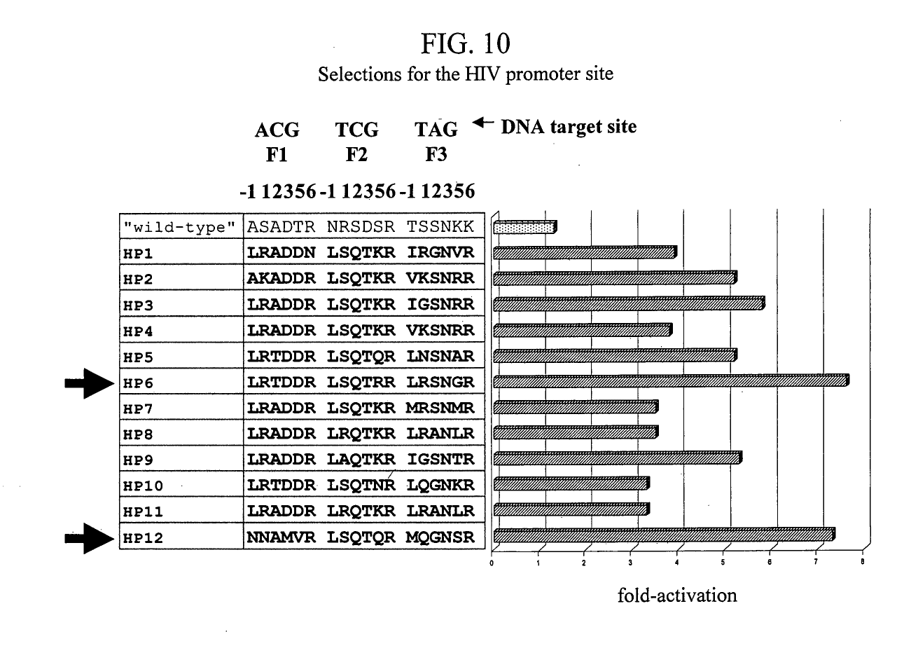

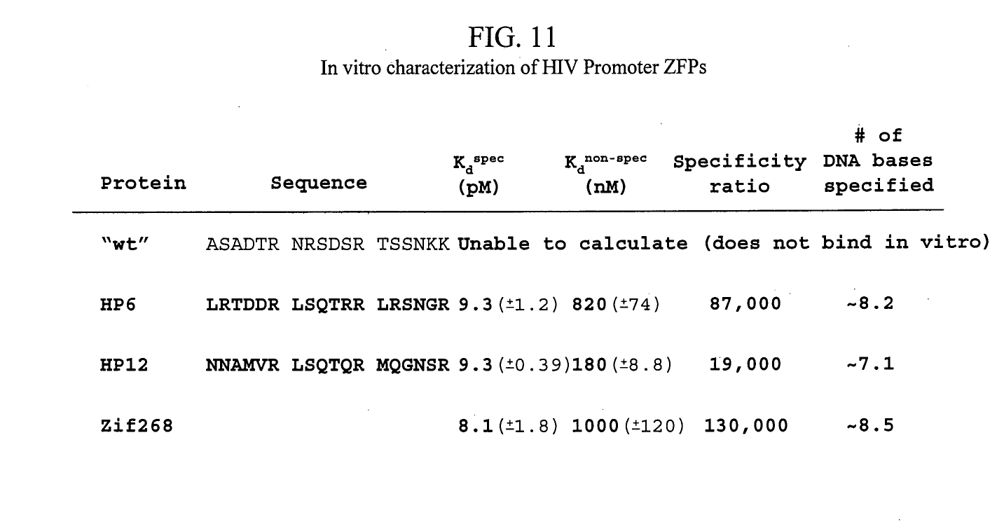

Twelve recombinant Zf proteins, termed HP1 through HP12, were selected (FIG. 10). Each of these Zf proteins differed in sequence from the Zf protein isolated by Isalan et al. (referred to as “wild-type” for the purposes of this example only). The two candidates, HP6 and HP12, were further characterized. Dissociation constants (K_{D}) for binding to the HIV-1 promoter sequence were measured and quantified using EMSAs. Specificity of binding was determined by comparing the K_{D} for binding to the HIV-1 promoter sequence to the K_{D} for binding to non-specific competitor DNA. FIG. 11 shows the KDS for specific and non-specific binding and the calculated “specificity ratios.” The results of this analysis demonstrate that both HP6 and HP12 bind to the HIV-1 promoter with high affinity and specificity. It was not possible to compare the target binding affinities and specificities of HP6 and HP12 to those of the “wild-type” protein in the present study, as the wild-type protein lacked sufficient affinity for its binding site to be measured by EMSA.

Thus, using the CSPO strategy of the present invention, recombinant Zfs with desirable target binding characteristics for the HIV-1 promoter have been identified.

### Example 8

### Methods for Bacterial Two-Hybrid Selections Media

Histidine-deficient medium utilized for selections has been previously described (Joung et al., PNAS 2000). Where required, the following antibiotics were added: carbenicillin (50 μg/ml in liquid medium, 100 μg/ml in solid medium), chloramphenicol (30 μg/ml), kanamycin (30 μg/ml). Isopropyl β-D-thiogalactoside (IPTG, to induce protein expression), 3-aminotriazole (3-AT, a HIS3 competitive inhibitor), and streptomycin were added at various concentrations to control selection conditions.

Plasmids and Strains

The αGal4 protein expression plasmid used has been described previously by Joung and colleagues. Zinc finger proteins (ZFPs) were expressed from vectors based on the previously described pBR-GP-Z123 plasmid (Joung). In these plasmids the inducible lacUV5 promoter directs the expression of a three-finger ZFP fused to a fragment of the yeast Gal11p protein. Reporter strains for both selections and in vivo transcriptional activation assays were constructed using standard methods. These strains contain a single copy F′-episome with the target DNA binding site positioned immediately upstream of a weak lac-promoter that controls the transcription of the selectable HIS3 and aadA genes (in “B2H selection strains”) or the lacZ reporter gene (in “B2H reporter strains”).

Low Stringency Selections:

A master library was introduced into an appropriately engineered “B2H selection strain” bearing the target subsite of interest and these transformed cells were plated on selective medium. Plasmids encoding ZFP variants that conferred the ability to survive on histidine-deficient medium containing 50 μM IPTG, 10 mM 3-AT and 20 μg/ml streptomycin were isolated and sequenced.

High Stringency Selections

A recombined library was introduced into the appropriate “B2H selection strain” bearing the full target sequence of interest and these transformants were plated on a series of histidine-deficient selective medium plates containing various concentrations of IPTG, 3-AT, and streptomycin. Candidates chosen for sequencing and subsequent analysis were picked from the most stringent selection conditions that permitted growth: 0 mM IPTG, 40 mM 3-AT, and 60 μg/ml streptomycin and 0 mM IPTG, 50 mM 3-AT, and 80 μg/ml streptomycin for both the BCR-ABL and HIV selections, and 50 mM IPTG, 25 mM 3-AT, 40 μg/ml streptomycin and 50 mM IPTG, 40 mM 3-AT, 60 μg/ml streptomycin for the erbB2 selections.

### Example 9

### Expression and Purification of Selected Proteins

Maltose binding protein-zinc finger protein fusions (MBP-ZFP) were expressed from a T7 promoter (plasmid pEXP1-DEST, Invitrogen, Carlsbad, Calif.) in the Expressway coupled in vitro transcription/translation system (Invitrogen, Carlsbad, Calif.). Proteins were expressed according to the manufacturer's instructions at 37° C. for 3.5 hours with the addition of 500 uM ZnCl₂ and the omission of the post-synthesis RNAse A treatment. Two to three synthesis reactions for each protein were pooled and the MBP-ZFP were batch affinity purified using amylose resin (New England Biolabs). Amylose beads were washed three times with 1 ml of WB1 [15 mM HEPES pH 7.8, 200 mM NaCl, 1 mM EDTA, 20 uM ZnSO₄, 1 mM DTT] prior to the addition of protein. Proteins were allowed to bind to beads in a total volume of 750 μl while rotating for 1.5 hours at 4° C. After binding, the slurry was spun at 2×g for 3 minutes at 4° C. and unbound proteins and in vitro transcription/translation components were removed from beads by pipet. Beads were subsequently washed twice with 700 μl WB 1 and twice more with 700 μl WB2 [binding buffer from Greisman and Pabo, Science (1997) with omission of acetylated BSA and addition of 1 mM DTT]. After the final centrifugation, supernatant was removed and beads were resuspended in 200 μl elution buffer [WB2+40 mM maltose]. Elution reactions were rotated at 22° C. for 30 minutes and supernatant containing MBP-ZFP was aliquoted and frozen for storage at −80° C.

While a preferred form of the invention has been shown in the drawing and described in some detail, variations in the preferred form will be apparent to those skilled in the art and thus the invention should not be construed as limited to the specific form shown and described, but instead is as set forth in the following claims.

We claim:

1. A method of selecting a zinc finger polypeptide that binds to a sequence of interest comprising at least two subsites, said method comprising the steps of:
a) incubating position-sensitive primary libraries with target site constructs under conditions sufficient to form first binding complexes, wherein said primary libraries comprise zinc finger polypeptides having one variable finger and at least one anchor finger, and wherein the target site construct has one subsite with a sequence identical to a subsite of the sequence of interest, and one or more subsites with sequences to which the anchor finger(s) bind;
b) isolating pools comprising nucleic acid sequences encoding polypeptides, wherein said polypeptides comprise the first binding complexes;
c) recombining the pools to produce a secondary library;
d) incubating the secondary library with the sequence of interest under conditions sufficient to form second binding complexes; and
e) isolating nucleic acid sequences encoding zinc finger polypeptides, wherein said polypeptides comprise the second binding complexes.

2. The method of claim 1, wherein the zinc finger polypeptide comprises at least two zinc fingers.

3. The method of claim 2, wherein the zinc finger polypeptide comprises three or more zinc fingers.

4. The method of claim 1, wherein the target site construct comprises the same number of base pairs as the sequence of interest.

5. The method of claim 1, wherein a subsite comprises 2-5 base pairs.

6. The method of claim 1, wherein the target site construct comprises two or more subsites.

7. The method of claim 1, wherein the target site construct comprises three or more subsites.

8. The method of claim 1, wherein one subsite of the target site construct has a sequence identical to the sequence of interest and the remaining subsite(s) in the target site construct have sequences that bind to the anchor finger(s).

9. The method of claim 8, wherein the remaining subsite(s) have sequences selected from the group consisting of SEQ ID NO. 5 (GCC subsite 1), SEQ ID NO. 6 (GAA subsite 2) and SEQ ID NO. 7 (GCA subsite 3).

10. The method of claim 1, wherein the primary libraries comprise polypeptides having at least one anchor finger that is derived from a naturally occurring zinc finger polypeptide.

11. The method of claim 1, wherein the anchor finger(s) bind to subsites in the target site construct with low affinity and/or low specificity.

12. The method of claim 10, wherein the zinc finger polypeptide is selected from the group consisting of Zif268, tramtrack, GLI, YYI and TFIIIA.

13. The method of claim 12, wherein the zinc finger polypeptide is Zif268.

14. The method of claim 10, wherein the zinc finger polypeptide is a phage-selected derivative of Zif268.

15. The method of claim 14, wherein the phage-selected derivative of Zif268 comprises sequences selected from the group consisting of SEQ ID NO:2 (DRSSLTR, finger 1), SEQ ID NO:3 (QGGNLVR, finger 2) and SEQ ID NO:4 (QAATLQR, finger 3).

16. The method of claim 1, wherein the variable finger is derived from a naturally occurring zinc finger polypeptide.

17. The method of claim 16, wherein the zinc finger polypeptide is selected from the group consisting of Zif268, tramtrack, YYI, GLI and TFIIIA.

18. The method of claim 17, wherein the zinc finger polypeptide is Zif268.

19. The method of claim 16, wherein the zinc finger polypeptide is a phage-selected derivative of Zif268.

20. The method of claim 19, wherein the phage-selected derivative of Zif268 comprises sequences selected from the group consisting of SEQ ID NO:2 (DRSSLTR, finger 1), SEQ ID NO:3 (QGGNLVR, finger 2) and SEQ ID NO:4 (QAATLQR, finger 3) and combinations thereof.

21. The method of claim 1, wherein the variable zinc finger comprises six randomized amino acid residue positions located within, or just amino-terminal to the start of, the recognition alpha helix of the zinc finger.

22. The method of claim 21, wherein the randomized amino acid residue positions are −1, +1, +2, +3, +5 and +6, numbered with respect to the start of the recognition alpha helix of the zinc finger.

23. The method of claim 21, wherein between 16 to 20 amino acids are represented at each randomized position.

24. The method of claim 21, wherein between 16 to 19 amino acids are represented at each randomized residue position.

25. The method of claim 21, wherein 16 amino acids are represented at each randomized residue position.

26. The method of claim 1, wherein the primary libraries are expressed in vitro.

27. The method of claim 1, wherein the primary libraries are expressed in expression systems selected from the group consisting of eukaryotic, prokaryotic and viral expression systems.

28. The method of claim 27, wherein the primary libraries are expressed in bacteria.

29. The method of claim 1, wherein incubation of the primary libraries is performed in vitro.

30. The method of claim 1, wherein incubation of the primary libraries is performed within a prokaryotic or eukaryotic cell.

31. The method of claim 30, wherein the incubation is performed within a bacterial cell.

32. The method of claim 1, wherein the isolated pools of nucleic acid sequences are recombined to produce a secondary library by PCR-mediated recombination.

33. The method of claim 1, wherein the secondary library is expressed in vitro.

34. The method of claim 1, wherein the secondary library is expressed in an expression system selected from the group consisting of a eukaryotic, prokaryotic and viral expression system.

35. The method of claim 34, wherein the secondary library is expressed in bacteria.

36. The method of claim 1, wherein incubation of the secondary library with the sequence of interest is performed at high stringency to form a high-affinity binding complex.

37. The method of claim 1, wherein incubation of the secondary library is performed in vitro.

38. The method of claim 1, wherein incubation of the secondary library is performed within a prokaryotic or eukaryotic cell.

39. The method of claim 38, wherein the incubation of the secondary library is performed within a bacterial cell.

40. A method of regulating the expression of a gene comprising contacting a zinc finger polypeptide according to claim 1 with a sequence of interest in the gene to form a binding complex, such that expression of the gene is regulated.

41. A zinc finger polypeptide according to claim 1, wherein the zinc finger polypeptide is fused to one or more functional domains.

42. A method of regulating the expression of a gene comprising contacting a zinc finger polypeptide according to claim 41 with a sequence of interest in the gene.

43. A zinc finger polypeptide according to claim 41 wherein the functional domain is selected from the group comprising transcriptional activation domain, transcriptional repressor domain, transcriptional silencing domain, acetylase domain, de-acetylase domain, methylation domain, de-methylation domain, kinase domain, phosphatase domain, dimerization domain, multimerization domain, nuclear localization domain, nuclease domain, endonuclease domain, resolvase domain and integrase domain.

44. A zinc finger polypeptide according to claim 41 wherein the functional domain is an endonuclease domain.

45. A method of regulating the expression of a gene comprising contacting a zinc finger polypeptide according to claim 43 with a sequence of interest in the gene to form a binding complex, such that expression of the gene is regulated.

46. A method of altering the structure of a gene comprising contacting a zinc finger polypeptide according to claim 43 with a sequence of interest in the gene to form a binding complex, such that the structure of the gene is altered.

47. A method of cleaving a sequence of interest comprising contacting a zinc finger polypeptide according to claim 44 with the sequence of interest to form a binding complex, such that the sequence of interest is cleaved.

48. A method of selecting a chimeric zinc finger polypeptide that binds to a sequence interest comprising at least two subsites, said method comprising the steps of
a) incubating position-sensitive primary libraries with target site constructs under conditions sufficient to form first binding complexes, wherein the position-sensitive primary libraries comprise zinc finger polypeptides having one variable finger and at least one anchor finger, and wherein the target site construcs have one subsite with a sequence identical to a subsite of the sequence of interest, and one or more subsites with sequences to which the anchor finger(s) bind;
b) recombining said pools to produce a secondary library;
c) incubating said secondary library with the sequence of interest under conditions sufficient to form second binding complexes;
d) isolating nucleic acid sequences encoding multi-finger zinc finger polypeptides, wherein said polypeptides comprise the second binding complexes, and
e) fusing a nucleic acid sequence encoding a functional domain to the nucleic acid sequence encoding the multi-finger zinc finger polypeptides, to form a nucleic acid encoding a chimeric multi-finger zinc finger polypeptide

49. The method of claim 48, wherein the zinc finger polypeptide comprises at least two zinc fingers.

50. The method of claim 49, wherein the zinc finger polypeptide comprises three or more zinc fingers.

51. The method of claim 48, wherein the target site construct comprises the same number of base pairs as the sequence of interest.

52. The method of claim 48, wherein a subsite comprises 2-5 base pairs.

53. The method of claim 48, wherein the target site construct comprises two or more subsites.

54. The method of claim 48, wherein the target site construct comprises three or more subsites.

55. The method of claim 48, wherein one subsite of the target site construct has a sequence identical to the sequence of interest and the remaining subsite(s) in the target site construct have sequences that bind to the anchor finger(s).

56. The method of claim 55, wherein the remaining subsite(s) have sequences selected from the group consisting of SEQ ID NO. 5 (GCC subsite 1), SEQ ID NO. 6 (GAA subsite 2) and SEQ ID NO. 7 (GCA subsite 3).

57. The method of claim 48, wherein the primary libraries comprise polypeptides having at least one anchor finger that is derived from a naturally occurring zinc finger polypeptide.

58. The method of claim 48, wherein the anchor finger(s) bind to subsites in the target site construct with low affinity and/or low specificity.

59. The method of claim 57, wherein the zinc finger polypeptide is selected from the group consisting of Zif268, tramtrack, GLI, YYI and TFIIIA.

60. The method of claim 59, wherein the zinc finger polypeptide is Zif268.

61. The method of claim 57, wherein the zinc finger polypeptide is a phage-selected derivative of Zif268.

62. The method of claim 61, wherein the phage-selected derivative of Zif268 comprises sequences selected from the group consisting of SEQ ID NO:2 (DRSSLTR, finger 1), SEQ ID NO:3 (QGGNLVR, finger 2) and SEQ ID NO:4 (QAATLQR, finger 3).

63. The method of claim 48, wherein the variable finger is derived from a naturally occurring zinc finger polypeptide.

64. The method of claim 63, wherein the zinc finger polypeptide is selected from the group consisting of Zif268, tramtrack, YYI, GLI and TFIIIA.

65. The method of claim 64, wherein the zinc finger polypeptide is Zif268.

66. The method of claim 63, wherein the zinc finger polypeptide is a phage-selected derivative of Zif268.

67. The method of claim 66, wherein the phage-selected derivative of Zif268 comprises sequences selected from the group consisting of SEQ ID NO:2 (DRSSLTR, finger 1), SEQ ID NO:3 (QGGNLVR, finger 2) and SEQ ID NO:4 (QAATLQR, finger 3) and combinations thereof.

68. The method of claim 48, wherein the variable zinc finger comprises six randomized amino acid residue positions located within, or just amino-terminal to the start of, the recognition alpha helix of the zinc finger.

69. The method of claim 68, wherein the randomized amino acid residue positions are −1, +1, +2, +3, +5 and +6, numbered with respect to the start of the recognition alpha helix of the zinc finger.

70. The method of claim 68, wherein between 16 to 20 amino acids are represented at each randomized position.

71. The method of claim 68, wherein between 16 to 19 amino acids are represented at each randomized residue position.

72. The method of claim 68, wherein 16 amino acids are represented at each randomized residue position.

73. The method of claim 48, wherein the primary libraries are expressed in vitro.

74. The method of claim 48, wherein the primary libraries are expressed in expression systems selected from the group consisting of eukaryotic, prokaryotic and viral expression systems.

75. The method of claim 74, wherein the primary libraries are expressed in bacteria.

76. The method of claim 48, wherein incubation of the primary libraries is performed in vitro.

77. The method of claim 48, wherein incubation of the primary libraries is performed within a prokaryotic or eukaryotic cell.

78. The method of claim 77, wherein the incubation is performed within a bacterial cell.

79. The method of claim 48, wherein the isolated pools of nucleic acid sequences are recombined to produce a secondary library by PCR-mediated recombination.

80. The method of claim 48, wherein the secondary library is expressed in vitro.

81. The method of claim 48, wherein the secondary library is expressed in an expression system selected from the group consisting of a eukaryotic, prokaryotic and viral expression system.

82. The method of claim 81, wherein the secondary library is expressed in bacteria.

83. The method of claim 48, wherein incubation of the secondary library with the sequence of interest is performed at high stringency to form a high-affinity binding complex.

84. The method of claim 48, wherein incubation of the secondary library is performed in vitro.

85. The method of claim 48, wherein incubation of the secondary library is performed within a prokaryotic or eukaryotic cell.

86. The method of claim 85, wherein the incubation of the secondary library is performed within a bacterial cell.

87. A method of regulating the expression of a gene comprising contacting a zinc finger polypeptide according to claim 48 with a sequence of interest in the gene to form a binding complex, such that expression of the gene is regulated.

88. A zinc finger polypeptide according to claim 48, wherein the zinc finger polypeptide is fused to one or more functional domains.

89. A method of regulating the expression of a gene comprising contacting a zinc finger polypeptide according to claim 48 with a sequence of interest in the gene.

90. A zinc finger polypeptide according to claim 88 wherein the functional domain is selected from the group comprising transcriptional activation domain, transcriptional repressor domain, transcriptional silencing domain, acetylase domain, de-acetylase domain, methylation domain, de-methylation domain, kinase domain, phosphatase domain, dimerization domain, multimerization domain, nuclear localization domain, nuclease domain, endonuclease domain, resolvase domain and integrase domain.

91. A zinc finger polypeptide according to claim 88 wherein the functional domain is an endonuclease domain.

92. A method of regulating the expression of a gene comprising contacting a zinc finger polypeptide according to claim 89 with a sequence of interest in the gene to form a binding complex, such that expression of the gene is regulated.

93. A method of altering the structure of a gene comprising contacting a zinc finger polypeptide according to claim 90 with a sequence of interest in the gene to form a binding complex, such that the structure of the gene is altered.

94. A method of cleaving a sequence of interest comprising contacting a zinc finger polypeptide according to claim 91 with the sequence of interest to form a binding complex, such that the sequence of interest is cleaved.

95. A position-sensitive primary library comprising zinc finger polypeptides having one variable finger and at least one anchor finger, wherein the position of the variable finger is the same as the position of the corresponding zinc finger in a multi-finger zinc finger polypeptide.
